(19) United States
(12) Patent Application Publication
(10) Pub. No.: US 2026/0267559 A1
(43) Pub. Date: Sep. 10, 2026

(54) NETWORK INTERFACE AND CONTROL METHOD THEREOF

(71) Applicant: Hitachi Vantara, Ltd., Yokohama-shi (JP)

(72) Inventors: Nobuhiro Yokoi, Tokyo (JP); Hitoshi Hayakawa, Tokyo (JP)

(73) Assignee: Hitachi Vantara, Ltd., Yokohama-shi (JP)

(21) Appl. No.: 19/304,890

(22) Filed: Aug. 20, 2025

(30) Foreign Application Priority Data
Mar. 10, 2025 (JP) 2025-037828

(51) Int. Cl. G06F 3/06

(52) U.S. Cl. CPC G06F 3/0659; G06F 3/0604; G06F 3/067

(57) ABSTRACT

A first virtual command transmission queue in which a command to be transmitted to an external device having an initiator attribute is stored, and a second virtual command transmission queue in which a command to be transmitted to an external device having a target attribute is stored are created in association with each core of a network interface, and the core adjusts a fetching amount of the command from the first virtual command transmission queue and a fetching amount of the command from the second virtual command transmission queue to satisfy preset expected values for initiator performance and target performance.

### BACKGROUND OF THE INVENTION

### Field of the Invention

The present invention relates to a network interface and a control method thereof, and is suitably applied to, for example, a smart network interface card (NIC) mounted on a storage controller of a storage device.

### Description of Related Art

Performance of a single network port of a storage device has been improved year by year, but the number of ports that can be mounted on the storage device has been reduced from viewpoints of electric power and cooling. Under such circumstances, in recent years, a configuration has been proposed in which one port is used for both connection to a host (target attribute) and connection to another storage device of a remote copy destination (initiator attribute).

On the other hand, in recent years, it has been proposed that a smart NIC in which information processing resources such as a general-purpose central processing unit (CPU) and a memory are installed on a network interface is mounted on a storage device, and protocol processing during communication with an external device is offloaded to the smart NIC to reduce a processing load of the storage device itself (for example, see PTL 1).

### Citation List

### Patent Literature

PTL 1: JP2023-181694A

### SUMMARY OF THE INVENTION

However, when one port is used for two attributes of the target attribute and the initiator attribute, there is a problem that performance of the port is not stable because both processing as a target (hereinafter, referred to as target processing) and processing as an initiator (hereinafter, referred to as initiator processing) compete for limited resources such as memories and port bands.

The invention has been made in view of the above points, and an object of the present invention is to provide a network interface capable of stabilizing performance of a port even when the port is used for two attributes of a target attribute and an initiator attribute, and a control method thereof.

In order to solve such problems, the invention provides a network interface to which protocol processing during communication between a host and an external device is offloaded from the host, including: a physical port that is connected to the external device; and a processor including one or a plurality of cores configured to communicate with the external device via the physical port, in which a virtual first virtual command transmission queue in which a command to be transmitted to the external device having an initiator attribute is stored and a virtual second virtual command transmission queue in which a command to be transmitted to the external device having a target attribute is stored are created in association with each of the cores, the command from the host for the external device having the initiator attribute is stored in the first virtual command transmission queue created in association with any one or a corresponding one of the cores, and the command from the host for the external device having the target attribute is stored in the second virtual command transmission queue created in association with any one or a corresponding one of the cores, each of the cores fetches the command stored in the first and second virtual command transmission queues created in association with the core itself from the first or second virtual command transmission queue and transmits the command to the corresponding external device, and each of the cores adjusts at least one of a fetching amount of the command from the first virtual command transmission queue and a fetching amount of the command from the second virtual command transmission queue created in association with the core itself to satisfy preset expected values for initiator performance and target performance.

The invention also provides a control method of a network interface to which protocol processing during communication between a host and an external device is offloaded from the host, the network interface including a physical port that is connected to the external device, and a processor including one or a plurality of cores configured to communicate with the external device via the physical port, the control method including: a first step of creating, in association with each of the cores, a virtual first virtual command transmission queue in which a command to be transmitted to the external device having an initiator attribute is stored and a virtual second virtual command transmission queue in which a command to be transmitted to the external device having a target attribute is stored; a second step of storing the command from the host for the external device having the initiator attribute in the first virtual command transmission queue created in association with any one or a corresponding one of the cores, and storing the command from the host for the external device having the target attribute in the second virtual command transmission queue created in association with any one or a corresponding one of the cores; and a third step of fetching, by each of the cores, the command stored in the first and second virtual command transmission queues created in association with the core itself from the first or second virtual command transmission queue and transmits the command to the corresponding external device, in which in the third step, each of the cores adjusts at least one of a fetching amount of the command from the first virtual command transmission queue and a fetching amount of the command from the second virtual command transmission queue created in association with the core itself to satisfy preset expected values for initiator performance and target performance.

According to the network interface and the control method thereof in the present invention, the initiator performance and the target performance can be maintained at desired expected values.

According to the present invention, it is possible to stabilize the performance of the port even when the port is used for two attributes of the target attribute and the initiator attribute.

### BRIEF DESCRIPTION OF THE DRAWINGS

FIG. 1 is a block diagram illustrating a configuration example of an information processing system;

FIG. 2 is a block diagram illustrating a configuration example of a network interface installed in a storage controller;

FIG. 3 is a block diagram illustrating a program configuration of the network interface in FIG. 2;

FIG. 4 is a block diagram illustrating an example of a correlation among programs of the network interface in FIG. 2;

FIG. 5 is a characteristic curve diagram showing a relation between initiator performance and target performance in an aggregation port;

FIG. 6 is a conceptual diagram illustrating a configuration example of an internal queue in the network interface of FIG. 2;

FIG. 7 is a chart illustrating a configuration example of a performance ratio management table;

FIG. 8A is a chart illustrating a configuration example of a transmission queue operation management table, and FIG. 8B is a chart illustrating a configuration example of a reception queue operation management table;

FIG. 9 is a chart illustrating a configuration example of an I/T mixed processing mode management table;

FIG. 10 is a chart illustrating a configuration example of a throttle amount management table;

FIG. 11 is a chart illustrating a configuration example of a connection type management table;

FIG. 12 is a state transition diagram showing core state transition related to a mixed processing mode;

FIG. 13 is a state transition diagram showing core state transition related to a throttle;

FIG. 14 is a ladder chart illustrating a flow of network interface initialization processing;

FIG. 15 is a ladder chart illustrating a flow of initiator command processing;

FIG. 16 is a ladder chart illustrating a flow of target command processing;

FIG. 17 is a flowchart illustrating a processing procedure of virtual command transmission queue processing;

FIG. 18 is a flowchart illustrating a processing procedure of transmission queue processing necessity determination processing;

FIG. 19 is a flowchart illustrating a processing procedure of processing mode determination processing;

FIG. 20 is a flowchart illustrating a processing procedure of throttle mode switching processing;

FIG. 21 is a flowchart illustrating a processing procedure of virtual command transmission queue processing count setting processing;

FIG. 22 is a flowchart illustrating another embodiment of the virtual command transmission queue processing count setting processing;

FIG. 23 is a flowchart illustrating a processing procedure of received packet enqueue processing;

FIG. 24A is a flowchart illustrating a processing procedure of virtual command reception queue processing;

FIG. 24B is a flowchart illustrating a processing procedure of virtual command reception queue processing;

FIG. 25 is a flowchart illustrating a processing procedure of setting combination pattern determination processing;

FIG. 26 is a flowchart illustrating a processing procedure of round trip time-corresponding processing;

FIG. 27 is a flowchart illustrating another embodiment of the round trip time-corresponding processing;

FIG. 28A is a flowchart illustrating a processing procedure of the virtual command transmission queue processing according to a second embodiment;

FIG. 28B is a flowchart illustrating the processing procedure of the virtual command transmission queue processing according to the second embodiment;

FIG. 29 is a conceptual diagram showing another embodiment; and

FIG. 30 is a conceptual diagram showing another embodiment.

### DESCRIPTION OF EMBODIMENTS

Hereinafter, an embodiment of the invention will be described in detail with reference to the drawings.

It should be noted that the following description and drawings are examples for describing the invention and are omitted and simplified as appropriate for clarity of description. The invention can be implemented in various other forms, and each component may be singular or plural unless otherwise specified.

The embodiment described below does not limit the invention according to the scope of claims, and not all combinations of elements described in the embodiment are essential to the solution of the invention.

In the following description, various types of information may be described by expressions such as "table", "list", and "queue", but the various types of information may be expressed by a data structure other than the above expressions, and in order to indicate that the various types of information do not depend on the data structure, expressions such as "xxx table", "xxx list", and "xxx queue" can be replaced with "xxx information". In the following description, when describing identification information, expressions such as "identification information" and "ID" are used, but these expressions are interchangeable.

In the following description, processing may be described with a "program" as a subject, but since the program is executed by a processor such as a CPU to perform predetermined processing using a storage resource such as a memory and/or an interface device such as a communication port, the subject of the processing can be replaced with a processor.

The processing described with the program as the subject can be expressed as processing performed by a computer such as a computer host or a storage device including a processor. In the following description, the expression "controller" may refer to a processor or a hardware circuit that performs some or all of processing performed by the processor.

The program may be installed in each computer from, for example, a program source such as a program distribution server or a computer-readable storage medium, and in this case, the program distribution server may include a processor and a storage resource, the storage resource may further store a distribution program and a program to be distributed, and the distributed program may be executed by a processor, causing the processor of the program distribution server to distribute the program to be distributed to other computers.

In the following description, in a case where a processor or a core thereof executes processing by executing a program, an expression such as "based on the XX program" or "according to the XX program" may be used in addition to the expression of "by executing the XX program", and these expressions have the same meaning.

Further, in the following description, two or more programs may be implemented as one program, or one program may be implemented as two or more programs.

Further, in the following description, a storage drive or simply a drive (storage) means a physical storage device, and typically, a non-volatile storage device such as an auxiliary storage device can be applied. As the drive, for example, a hard disk device or a solid state drive (SSD) can be applied.

In the following description, "RAID" is an abbreviation for redundant array of inexpensive disks. A RAID group includes a plurality of drives (typical drives of the same type), and stores data according to a RAID level associated with the RAID group. The RAID group may be referred to as a parity group. The parity group is, for example, a RAID group that stores parities.

A network interface in the following embodiment may be mounted on an information processing system including a server system and a storage system. The storage system may include a storage controller and a drive box. The network interface may include, for example, a general-purpose processor, a memory, a network controller, and an interface with a host device.

### First Embodiment

### Configuration of Information Processing System According to Present Embodiment

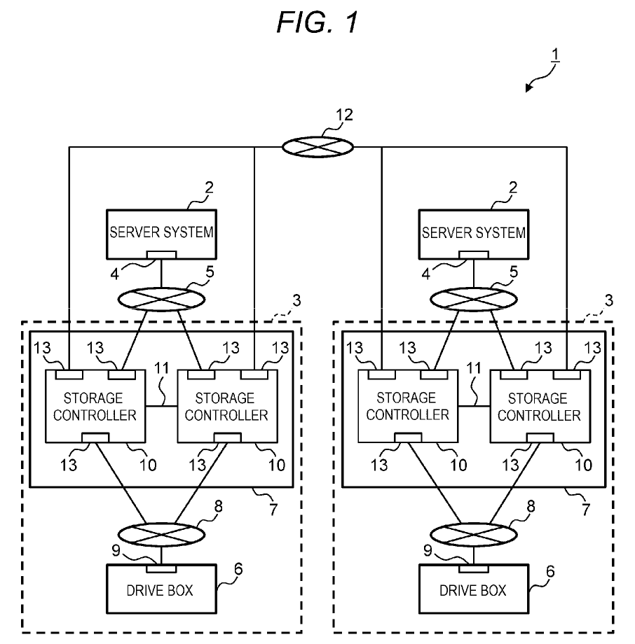

FIG. 1 illustrates an information processing system 1 according to the present embodiment. The information processing system 1 includes one or a plurality of server systems 2 and one or a plurality of storage systems 3.

The server system 2 is a host device in which various applications for managing databases and providing Web services are installed, and is implemented by a computer device including information processing resources such as one or a plurality of processors, a memory, and an auxiliary storage device.

The server system 2 is also mounted with a network interface 4, and the network interface 4 is connected to a storage controller 10 of the storage system 3 via a front end network 5. The server system 2 reads and writes data created by an installed application from and to the storage system 3 via the front end network 5.

It should be noted that the server system 2 may be implemented by a plurality of servers constituting a distributed computing system, and these servers may each include the network interface 4 and may be connected to the storage controller 10 or another server system 2 via the network interface 4.

The storage system 3 includes one or a plurality of drive boxes 6 and one or a plurality of storage devices 7.

The drive box 6 is a storage drive mounted with a plurality of drives that provide a storage area for the server system 2 to read and write data. In practice, a plurality of large-capacity non-volatile drives such as hard disk devices and SSDs are mounted on the drive box 6. The drive box 6 is connected to one or a plurality of storage controllers 10 via a back end network 8.

Therefore, the drive box 6 is mounted with a network interface 9 that functions as an interface device during communication with the storage controller 10 via the back end network 8. The drive box 6 is also mounted with an internal switch for connecting a plurality of mounted drives and the storage controller 10, a processor and a memory used for transfer processing, and the like.

It should be noted that, in order to improve availability of data in the drive box 6, a RAID may be assembled between the drives mounted on the drive box 6, and further, a RAID may be assembled between the plurality of drive boxes 6.

The storage device 7 includes a plurality of redundant storage controllers 10. FIG. 1 illustrates a case where the storage device 7 includes two storage controllers 10 having a redundant configuration, and in the following description, it is assumed that the storage device 7 includes two storage controllers 10. The two storage controllers 10 having the redundant configuration have the same configuration. By adopting such a redundant configuration of the storage controllers 10, even when one storage controller 10 is blocked due to maintenance, failure, or the like, storage processing can be continued by the other storage controller 10.

One or a plurality of processors and memories are mounted on the storage controller 10. Each processor reads and writes data from and to a corresponding storage area in the drive box 6 in response to a read command or a write command from the server system 2. The memory is used as a main storage device of the processor to store an execution program such as a storage control program, a management table referred to by the processor, and the like. The memory is also used as a disk cache (cache memory) of the storage controller 10. It should be noted that the memory may be implemented by a semiconductor memory such as a synchronous dynamic random access memory (SDRAM), or may be implemented by combining a volatile memory and a non-volatile memory such as a storage class memory (SCM).

The storage controller 10 is connected to another storage controller 10 at a short distance via an inter-storage controller network 11, and is connected to another storage controller 10 at a medium distance or a long distance via an external network 12. Therefore, the storage controller 10 is mounted with a network interface 13 as an interface device for another storage controller 10 connected via the external network 12.

The storage controller 10 is also mounted with another network interface 13 as an interface device for the server system 2 and another network interface 13 as an interface device for the drive box 6. The network interface 13 for the drive box 6 is used when data is exchanged between the drive boxes 6 in response to a request from the server system 2 or for transmitting information regarding processing such as data copying to the drive box 6.

It should be noted that in the case of the present embodiment, the network interface 13 mounted on the storage controller 10 includes a smart network interface card (smart NIC). The smart NIC is an adapter circuit board with built-in general-purpose processor and memory, operates an operating system, and operates software thereon to perform processing of a network protocol (protocol processing).

With the smart NIC, for example, the same operating system (OS) as that operating on the server system 2 can be operated, and a software protocol stack, an application, and the like used on the server system 2 can be operated. By implementing the protocol processing by software using a smart NIC mounted with a general-purpose processor and a memory, it is possible to flexibly support a plurality of protocols. That is, it becomes easier to handle various protocols. Further, while handling various protocols, a load of the protocol processing can be offloaded from the storage controller 10 to the network interface 13.

Various functions of the smart NIC may be partially implemented by using a hardware offload engine. The smart NIC may have a configuration using a field programmable gate array (FPGA), and in this case, each function is implemented on the FGPA. Further, as another form, the smart NIC may have a configuration as dedicated interface hardware in which all functions thereof are implemented by hardware.

The front end network 5 is a storage area network that connects the server system 2 and the storage controller 10. As the front end network 5, for example, an IP network such as internet small computer system interface (iSCSI) or non-volatile memory express (NVMe) over fabrics (NVMe-oF) can be used.

The back end network 8 is a network that connects the storage controller 10 and the drive box 6. As the back end network 8, for example, an IP network such as iSCSI or NVMe-oF can be used. A serial attached SCSI (SAS) or NVMe other than the IP network can also be applied.

The inter-storage controller network 11 is a network used for redundancy of the storage controllers 10, and is implemented by broad band interconnect. It is possible to perform duplication of write data, sharing of metadata, and the like using the inter-storage controller network 11.

The external network 12 is implemented by a wide area network (WAN) or a local area network (LAN). The external network 12 performs communication using a protocol data unit (PDU) of iSCSI or NVMe-oF, for example, in a network in which a data link layer is Ethernet (registered trademark), an Internet device is an Internet protocol, and a transport layer is a transmission control protocol (TCP) or a user datagram protocol (UDP). The external network 12 can adopt a form of an Internet line or a dedicated line. It should be noted that a communication delay of the external network 12 may increase depending on a distance. In this case, when a network device is not configured only by a lossless device, occurrence of packet loss is assumed, but an occurrence rate thereof varies depending on a line type.

It should be noted that the information processing system 1 and the storage system 3 may include components other than those shown above. For example, each network may have network devices such as switches and routers connected therebetween, and may also have devices for monitoring and maintenance connected thereto. A configuration of connecting to a storage service on a public cloud via an external network may also be adopted.

In the network interface 4 of the server system 2, initiator software in iSCSI or NVMe-oF is installed in order to read and write data from and to the drive box 6 via the storage controller 10. On the other hand, target software is installed in the network interface 13 on the server system 2 side of the storage controller 10.

In addition, initiator software in iSCSI or NVMe-oF is installed in the network interface 13 on the drive box 6 side of the storage controller 10 in order to read and write data in the drive box 6. On the other hand, target software is installed in the network interface 9 of the drive box 6.

Further, initiator software in iSCSI or NVMe-oF is installed in the network interface 13 of the storage controller 10 in order to read and write data from and to another storage device 7. On the other hand, target software is installed in the network interface 13 of the storage controller 10 of the other storage device 7.

It should be noted that the network interfaces 4 and 9 other than the network interface 13 mounted on the storage controller 10 may be a normal NIC that does not have the performance of the smart NIC (hereinafter, referred to as a normal NIC as appropriate). For example, a configuration can be applied in which a normal NIC is used as the network interface 4 mounted on the server system 2 and operated as an initiator, and a smart NIC is used as the network interface 13 in the storage controller 10 and operated as a target.

A part of the network interfaces 13 connected to the back end network 8 of the storage controller 10 may be a disk board (DKB) that does not have the functions of a smart NIC, and the drive box 6 may be accessed by SAS or NVMe.

### Detailed Configuration of Network Interface

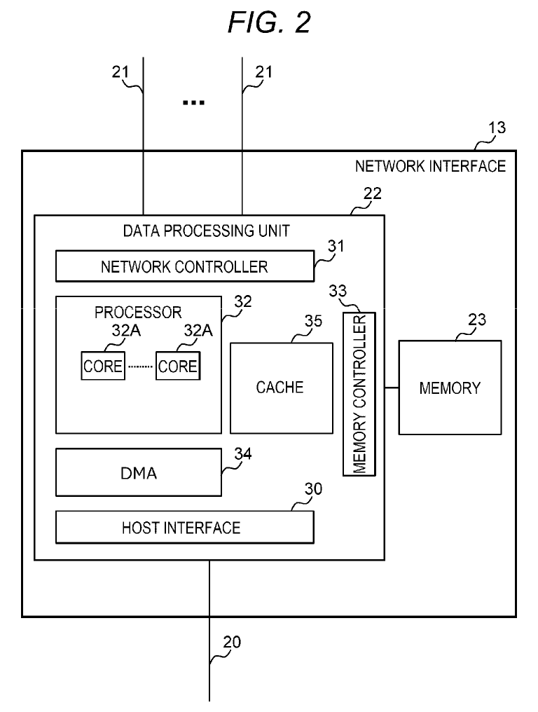

FIG. 2 illustrates a configuration example of the network interface 13 mounted on the storage controller 10 of the storage device 7. The network interface 13 is connected to another device on which the network interface 13 itself is mounted via a host bus 20. The device is, for example, the storage controller 10, an internal configuration of the server system 2, or the drive box 6. The network interface 13 is connected to other devices by, for example, IP network connection via a network path 21.

The network interface 13 includes a data processing unit (DPU) 22 and a memory 23. The data processing unit 22 includes a host interface 30 for connecting to the host bus 20, and a network controller 31 that is connected to the network path 21 and performs processing of a network protocol. The data processing unit 22 includes a processor 32, a memory controller 33, a direct memory access (DMA) controller 34, and a cache 35.

The host interface 30 is a bus that connects the network interface 13 to a host system (hereinafter, simply referred to as a host or a network interface host as appropriate) such as the storage controller 10, the server system 2, or the drive box 6. The host bus 20 is a broad-band and high-speed interconnect, and is configured to be connected to, for example, a processor or the like of a device on which the host bus 20 is mounted by peripheral component interconnect express (PCIe).

The host interface 30 is an interface for connecting the network interface 13 and the network interface host via the host bus 20. For example, when the host bus 20 is a PCI, a physical layer (PHY) of PCIe may be included. The DMA controller 34 exchanges data between the memory 23 in the network interface 13 and the memory of the network interface host or between the respective caches thereof.

The network path 21 is, for example, an IP network path, and adopts a network form of WAN, LAN, or SAN. In the network interface 13, communication is performed via one network path 21 or two or more network paths 21 in consideration of redundancy.

The network controller 31 is an interface for connecting the network interface 13 to the network path 21. The network controller 31 executes, for example, processing of a physical layer such as a PHY and stateless processing of a data link layer, an Internet layer, and a transport layer. The network controller 31 performs, for example, check sum processing and frame processing.

The network controller 31 supports, for example, the Ethernet, IP, TCP, UDP, and the like. The network controller 31 may include an offload engine such as an Internet Security Protocol (IPsec), a Transport Layer Security (TLS), or a Data Integrity Field (DIF). Further, the network controller 31 may be configured to be connected to an optical cable, a copper cable, or the like.

The processor 32 is implemented by a general-purpose processor, and executes an operating system also used in, for example, the server system 2. The processor 32 further executes other software to perform protocol processing, command processing, management of the network interface 13, and the like. The processor 32 may have any configuration, and for example, the processor 32 may include one or a plurality of CPUs or micro processing units (MPUs). Hereinafter, it is assumed that the processor 32 includes a plurality of cores 32A.

The memory 23 is implemented by a semiconductor memory such as a SDRAM. The memory 23 may be implemented by combining such a semiconductor memory and a non-volatile memory such as an SCM. The memory 23 stores, as a main storage device of the processor 32, an execution program (an instruction code for protocol processing or command processing), a management table referred to by the processor 32, and the like. The memory 23 is also used as a buffer for commands and data transmitted and received via the network. Further, the memory 23 includes a queuing interface for the host interface 30 and the network controller 31, and is used to store a descriptor, an index, and the like of a queue.

The memory controller 33 is an interface for controlling the memory 23 when reading and writing data from and to the memory 23. The memory controller 33 controls the cache 35 to optimize a data flow between the processor 32 and the memory 23. The memory controller 33 may be built in the processor 32, for example. The memory controller 33 may be built in, for example, the data processing unit 22 or the network controller 31.

The cache 35 is used to temporarily store data between the memory 23 and the processor 32. The processor 32 can access the cache 35 at a higher speed than the memory 23. The data read from the memory 23 is stored in the cache 35. When accessing the memory 23, the processor 32 first accesses the cache 35, and reads data from the cache 35 when the data to be read exists in the cache 35. The cache 35 may have a hierarchical structure. In this case, the caches are called L1 cache, L2 cache, and the like from the hierarchy closest to the processor 32. The processor 32 and the DMA controller 34 ensure coherence (have consistency) with respect to the cache 35.

It should be noted that the information processing system 1 and the storage system 3 may include elements other than those described above, and for example, a module and an interface for monitoring and maintenance, and a non-volatile storage device that stores an operating system and a software program operating on the network interface 13 may be added.

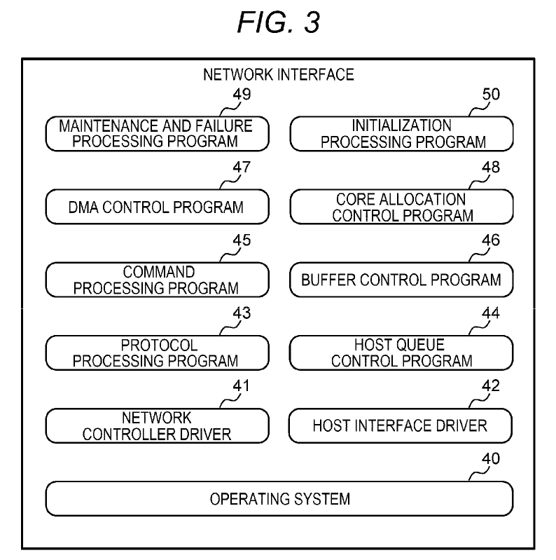

FIG. 3 illustrates a configuration example of a program of the network interface 13. In the case of the present embodiment, in order to achieve a software-based changeable processing function, the network interface 13 operates an operating system using the general-purpose processor 32, the cache 35, and the memory 23, and then operates software programs of various kinds of processing.

The network interface 13 includes, as software programs, an operating system 40, a network controller driver 41, a host interface driver 42, a protocol processing program 43, a host queue control program 44, a command processing program 45, a buffer control program 46, a DMA control program 47, a core allocation control program 48, a maintenance and failure processing program 49, and an initialization processing program 50.

These software programs are loaded into the memory 23 (FIG. 2) and processed by each core 32A of the processor 32 (FIG. 2). Some instructions are stored in the cache 35 (FIG. 2). It should be noted that processing that is more efficient when implemented in hardware, such as data integrity field (DIF), cyclic redundancy check (CRC), encryption, compression, hash, and parity processing, may be implemented in hardware and controlled by software.

The operating system 40 is a basic software program serving as a basis for operating the network interface 13, and manages the entire network interface 13. The operating system 40 is software that provides a common usage environment for each piece of software that runs on the processor 32 of the network interface 13. As the operating system 40, an embedded operating system can be applied, and a general-purpose operating system operating on a server such as Linux (registered trademark) can also be applied.

The network controller driver 41 is driver software for controlling the network controller 31 (FIG. 2). The network controller driver 41 is driver software having a function of delivering, to the network controller 31, a parameter set for packet processing that is offloaded when a packet is generated or a packet is received. The network controller driver 41 delivers a communication packet generated by the protocol processing program 43 to the network controller 31 to transmit the communication packet. The network controller driver 41 also has a function of delivering the communication packet received from the network controller 31 to the protocol processing program 43.

The host interface driver 42 is driver software for controlling the host interface 30. Communication between the network interface 13 and the network interface host (here, the storage controller 10) is executed via the host interface driver 42.

The protocol processing program 43 is a program having a function of performing generation and transmission processing on a communication packet (hereinafter, referred to as a transmission packet as appropriate) to be transmitted in cooperation with the command processing program 45, the DMA control program 47, and the network controller driver 41. The protocol processing program 43 also has a function of processing the received communication packet (hereinafter, referred to as a received packet as appropriate), fetching control information and information and data such as iSCSI PDU and NVMe-oF PDU, and delivering the fetched information to the command processing program 45.

The protocol processing program 43 performs IP header processing of the Internet protocol layer, TCP header processing and UDP header processing of the transport layer, and further iSCSI processing and NVMe-oF processing. For example, the protocol processing program 43 executes a program such as a socket program, an iSCSI initiator or target, or an NVMe-oF initiator or target.

The host queue control program 44 is a program having a function of controlling a queue interface for exchanging commands with the network interface host. The host queue control program 44 manages an internal queue of a command to be transmitted to the network interface host in the network interface 13 and an internal queue of a command received from the network interface host. The host queue control program 44 stores (enqueues) a command to the network interface host or a command from the network interface host in the internal queue. Further, the host queue control program 44 controls Head and Tail when the internal queue has, for example, a ring structure. Further, the host queue control program 44 controls Head and Tail of a command queue held by the network interface host.

The command processing program 45 is a program having a function of receiving a command for controlling the host network interface 13 (network interface in which the command processing program 45 is installed) from the network interface host and controlling the host network interface 13 in response to the received command. The command processing program 45 receives a processing request of the network protocol from the network interface host, activates the protocol processing program 43, and returns a processing result of the protocol processing program 43 to the network interface host. The command processing program 45 activates the DMA control program 47 for data transfer with the memory ensured by the network interface host, and performs response processing. The command processing program 45 also performs initial setting, setting change, software replacement of the network interface 13, notification to the network interface host during failure, and the like.

The buffer control program 46 is a program having a function of controlling a buffer that temporarily holds data in the memory 23 or the cache 35. The buffer stores data received from the network and transferred to the network interface host or data received from the network interface host and transmitted to the network.

The DMA control program 47 is, for example, a program having a function of performing interface processing with DMA hardware in order to control data transfer between a memory ensured on the network interface host side and the memory 23 or the cache 35 on the network interface 13.

The core allocation control program 48 is a program having a function of allocating the cores 32A of the processor 32 to each physical port of the host network interface 13. For example, when the number of physical ports of the host network interface 13 is two and the number of cores 32A is eight, the core allocation control program 48 assigns four cores 32A, which is half the total number of cores, to each physical port.

The maintenance and failure processing program 49 is a program having a function of supporting software update of the host network interface 13, detection of hardware failure, notification to the network interface host, and the like. The initialization processing program 50 is a program having a function of initializing hardware including the host network interface 13 and performing initialization processing of various software.

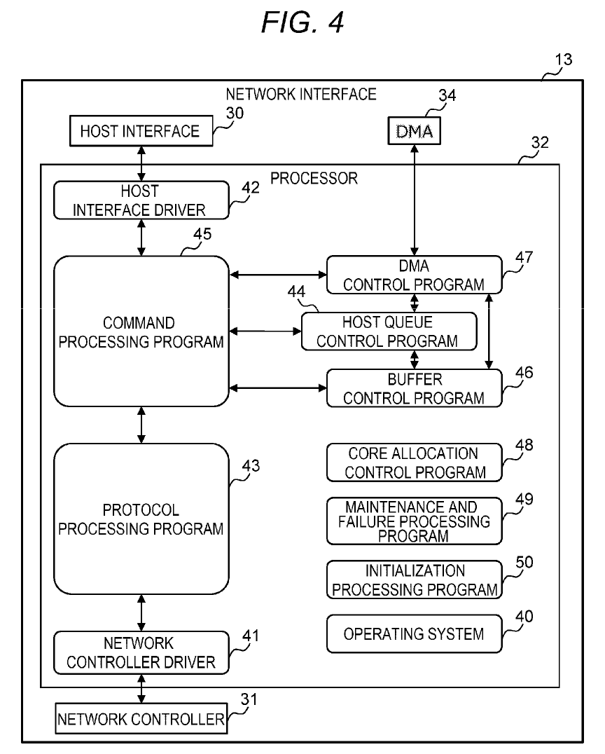

FIG. 4 shows a relation between programs of the network interface 13 described above with reference to FIG. 3. In the network interface 13, an operating system 40 operates, and each software program operates based on the operating system 40. The network interface 13 executes maintenance such as software update, failure processing, and processing such as initial setting, by the maintenance and failure processing program 49 and the initialization processing program 50. The failure processing includes, for example, failure detection and collection of dump trace information and log information such as statistical information and error information.

The network controller driver 41 controls the host network controller 31, stores the transmitted communication packet in a packet buffer (not illustrated) defined on the memory 23, and acquires the communication packet received by the network controller 31 so far from the packet buffer. The network controller driver 41 performs setting for offloading frame processing of the data link layer, the Internet protocol layer, and the transport layer, and state processing such as check sum calculation.

The protocol processing program 43 performs protocol processing such as IP, TCP, UDP, iSCSI PDU processing, and NVMe-oF PDU processing in response to the operation of the network controller driver 41. The protocol processing program 43 processes the communication packet received by the network controller driver 41 to fetch control information, information such as iSCSI PDU and NVMe-oF PDU, and data. It should be noted that the communication packet received by the network controller driver 41 may not include data. The protocol processing program 43 delivers the fetched information to the command processing program 45. The data can be transferred to the network interface host via a buffer controlled by the buffer control program 46 or without going through the buffer.

The protocol processing program 43 includes information acquired from the command processing program 45 and data transmitted from the network interface host in a communication packet to be transmitted to the network. The data may be transferred to the network with or without going through a buffer controlled by the buffer control program 46. It should be noted that the communication packet may not include data.

The command processing program 45 executes command processing in cooperation with the host queue control program 44, the buffer control program 46, and the DMA control program 47. The command processing program 45 controls the host interface 30 through the host interface driver 42. The command processing program 45 exchanges a transmission command or a reception command for network communication with the network interface host, such as information for generating PDU of iSCSI or NVMe-oF, analyzed information, or PDU itself. The command is exchanged with the network interface host using the queue interface. The host queue control program 44 controls the queue interface.

The command processing program 45 generates a command that can be processed by the network interface host from a result of the protocol processing program 43, and stores the command in the queue via the host queue control program 44. The command processing program 45 acquires the command generated by the network interface host from the queue, and sets and uses each function in the network interface 13 such as the protocol processing program 43. It should be noted that the command stored in the queue can be exchanged between the network interface host and the network interface 13 by the DMA control program 47 using the DMA controller 34.

### Aggregation Port Performance Stabilization Function According to Present Embodiment

Next, an aggregation port performance stabilization function installed in the network interface 13 of the storage controller 10 of the storage device 7 will be described. Here, the "aggregation port" refers to a physical port used for both connection to an external device having an initiator attribute (here, another storage system 3 whose data transfer destination is the server system 2 or the host storage system 3) and connection to an external device having a target attribute (here, another storage system 3 of the data transfer destination).

First, a buffer control function installed in the network interface 13 will be described. In the network interface 13 mounted on the storage controller 10 of the present embodiment, a buffer control function as disclosed in JP2023-142021A is installed.

Specifically, the host network interface 13 uses data buffers of a plurality of sizes. The data buffer is a buffer that temporarily stores data exchanged with the storage controller 10. The buffer size is set according to a transfer data size of the supported network protocol. For example, a plurality of data buffers are ensured for each supported transfer data size during initialization (activation). That is, in the host network interface 13, a plurality of data buffers each having a size of 8 KB, 32 KB, 256 KB, or the like are ensured during the activation. Accordingly, it is possible to selectively use the buffers depending on whether a data length is short or the data length is long while reducing a buffer ensuring load in I/O.

When using the data buffer, the network interface 13 selects and uses a recently used area (the buffer released immediately before). Therefore, it is possible to localize an access range to the data buffer and increase a cache hit rate. Since a memory access count can be reduced by a cache hit of the transfer data, it is possible to prevent a performance decrease due to a memory neck.

Further, the network interface 13 limits the number of buffers used for data transfer to be simultaneously processed so that data does not overflow from the cache as much as possible. As a result, it is possible to increase a cache hit frequency, reduce memory access, and prevent a performance decrease due to a pressure on a memory band.

Hereinafter, an operation mode in which the above-described processing based on the buffer control function is performed is referred to as a throttle mode.

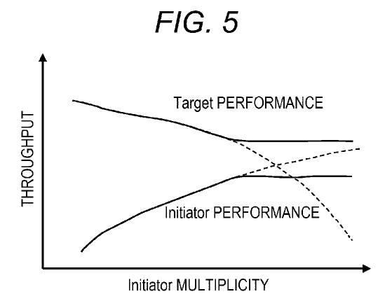

The aggregation port performance stabilization function will continue to be described. As described above, when one physical port is used for connection with an external device having an initiator attribute and for connection with an external device having a target attribute, processing (hereinafter, referred to as initiator processing) for a command, a response, and the like (hereinafter, referred to as initiator command) exchanged with the external device having the initiator attribute and processing (hereinafter, referred to as target processing) for a command, a response, and the like (hereinafter, referred to as target command) exchanged with the external device having the target attribute compete for limited resources. As a result, as indicated by broken lines in FIG. 5, there is a problem that when performance as an initiator is increased, performance as a target cannot be controlled and is excessively decreased. In this case, as indicated by solid lines in FIG. 5, it is desirable to ensure the performance as the initiator while maintaining the performance as the target at a certain level.

Therefore, in the present embodiment, the aggregation port performance stabilization function of preventing the performance of the target processing and the initiator processing of the storage controller 10 from being lower than expected performance by controlling a balance between a communication amount as the initiator and a communication amount as the target in the network interface 13 mounted on the storage controller 10, is installed.

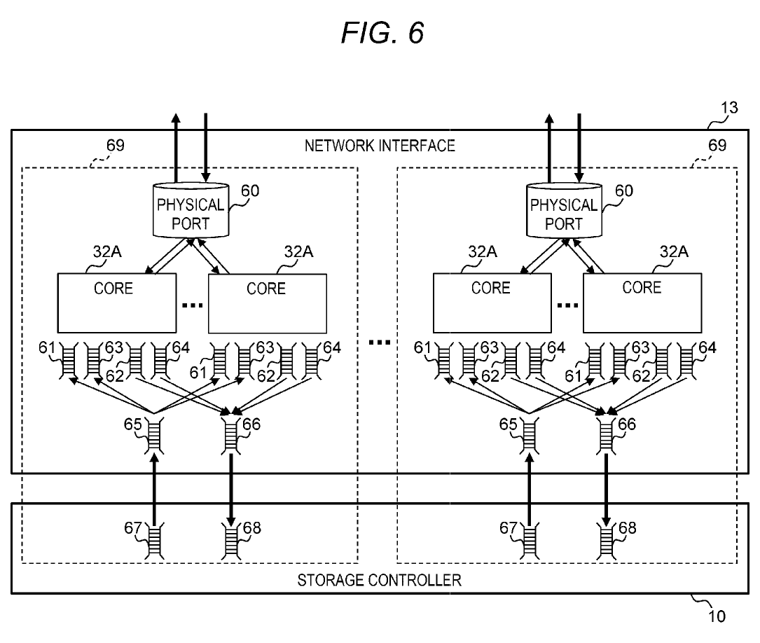

In practice, in the information processing system 1, as illustrated in FIG. 6, a virtual transmission queue and a virtual reception queue for the initiator command and the target command are created in the network interface 13 in association with the cores 32A of the processor 32 assigned to the physical ports 60 of the network interface 13.

Hereinafter, a virtual transmission queue for the initiator command is referred to as a virtual initiator command transmission queue 61, a virtual reception queue for the initiator command is referred to as a virtual initiator command reception queue 62, a virtual transmission queue for the target command is referred to as a virtual target command transmission queue 63, and a virtual reception queue for the target command is referred to as a virtual target command reception queue 64.

In the information processing system 1, a transmission queue (hereinafter, referred to as an interface-side physical command transmission queue) 65 for receiving a command or the like from the storage controller 10 by the network interface 13 and a reception queue (hereinafter, referred to as an interface-side physical command reception queue) 66 for delivering a command or the like received by the network interface 13 via the network to the storage controller 10 are created in the network interface 13 in association with each physical port 60 of the network interface 13.

It should be noted that an actual state of the command stored in the interface-side physical command transmission queue 65 or the interface-side physical command reception queue 66 may not be on the network interface 13 side, and the actual state of the command may be in a host-side physical command transmission queue 67 or a host-side physical command reception queue 68 on the storage controller side, and the command may be directly transferred to the virtual transmission queue or the virtual reception queue therefrom. For example, if there is a command in the host-side physical command transmission queue 67, there may be a buffer with a capacity corresponding to the maximum number of transferred commands that are temporarily stored when the commands are subjected to DMA to the network interface 13, or there may be an interface-side physical command transmission queue 65, and a method may be used in which a content of the command subjected to DMA is viewed and distributed to the corresponding virtual transmission queue. When a command of the virtual reception queue of the network interface 13 is transmitted to the host-side physical command reception queue 68, the interface-side physical command reception queue 66 is used only for managing a position to which the command is transmitted by matching positions of the Head and the Tail of the host-side command reception queue 68, and the command stored in the virtual reception queue may be directly transferred to the host-side physical command reception queue 68 by DMA.

Each of the virtual initiator command transmission queue 61, the virtual initiator command reception queue 62, the virtual target command transmission queue 63, the virtual target command reception queue 64, the interface-side physical command transmission queue 65, and the interface-side physical command reception queue 66 is a First-In First-Out (FIFO) queue having a ring structure, and commands are sequentially read from the Head thereof, and a new command is stored in the Tail area. The Head and the Tail are managed by the network interface 13 and the storage controller 10.

Further, in the storage controller 10, a transmission queue (hereinafter referred to as the host-side physical command transmission queue) 67 for delivering a command or the like from the storage controller 10 to the network interface 13 is created in association with each interface-side physical command transmission queue 65, and a reception queue (hereinafter referred to as the host-side physical command reception queue) 68 for delivering a command or the like stored in the interface-side physical command reception queue 66 from the network interface 13 to the storage controller 10 is created in association with each interface-side physical command reception queue 66.

The host-side physical command transmission queue 67 and the host-side physical command reception queue 68 are also First-In First-Out (FIFO) queues having a ring structure, and commands are sequentially read from the Head and a new command is stored in the Tail area. The Head and the Tail are managed by the storage controller 10 and the network interface 13.

Hereinafter, the virtual initiator command transmission queue 61, the virtual initiator command reception queue 62, the virtual target command transmission queue 63, and the virtual target command reception queue 64 created in association with the respective cores 32A assigned to the same physical port 60 of the network interface 13, and the interface-side physical command transmission queue 65, the interface-side physical command reception queue 66, the host-side physical command transmission queue 67, and the host-side physical command reception queue 68 corresponding thereto are collectively referred to as a physical port-corresponding command queue group 69 of the physical port 60.

The virtual initiator command reception queue 62 stores an initiator command from, for example, a replication destination storage system (hereinafter referred to as a data transfer destination storage system) 3 distributed to the corresponding core 32A. The virtual target command reception queue 64 stores a target command from the server system 2 (FIG. 1) distributed to the corresponding core 32A.

The initiator command and the target command stored in the virtual initiator command reception queue 62 and the virtual target command reception queue 64, respectively, are merged and stored in the Tail area of the interface-side physical command reception queue 66 in the same physical port-corresponding command queue group 69, and then transferred to the Tail area of the host-side physical command reception queue 68, thereby being acquired by the storage controller 10.

Among physical commands stored in the host-side physical command transmission queue 67 by the storage controller 10 and transferred to the interface-side physical command transmission queue 65 in the same physical port-corresponding command queue group 69, the initiator command to be transmitted to the data transfer destination storage system 3 by the corresponding core 32A is distributed to and stored in the virtual initiator command transmission queue 61.

Similarly, among physical commands stored in the host-side physical command transmission queue 67 by the storage controller 10 and transferred to the interface-side physical command transmission queue 65 in the same physical port-corresponding command queue group 69, the target command to be transmitted to the server system 2 by the corresponding core 32A is distributed to and stored in the virtual target command transmission queue 63.

Then, the initiator command stored in the virtual initiator command transmission queue 61 and the target command stored in the virtual target command transmission queue 63 are fetched from the virtual initiator command transmission queue 61 and the virtual target command transmission queue 63 by the corresponding cores 32A and transmitted to the server system 2 and the corresponding data transfer destination storage system 3.

In this case, the core 32A adjusts processing amounts of the initiator command and the target command by performing weighting control on a fetching amount of the initiator command stored in the virtual initiator command transmission queue 61 or the virtual initiator command reception queue 62 and a fetching amount of the target command stored in the virtual target command transmission queue 63 or the virtual target command reception queue 64, thereby adjusting a balance between initiator performance and target performance.

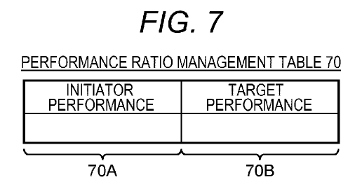

It should be noted that in the present embodiment, weights in the weighting control are expected values for the initiator performance and the target performance stored in a performance ratio management table 70 described below with reference to FIG. 7, but the weights may be controlled according to the number of sessions/connections, delay, data length, and I/O type.

In the present embodiment, a fetching amount of the received packet from the packet buffer provided in the memory 23 is adjusted so that the host-side physical command transmission queue 67 and the interface-side physical command transmission queue 65 are not clogged by the weighting control as described above. Therefore, it is possible to prevent retransmission processing in the storage controller 10 due to a processing timeout. It should be noted that the retransmission processing uses a mechanism of retransmission of TCP in the network interface 13.

Further, in the present embodiment, each core 32A in the same physical port-corresponding command queue group 69 establishes a session with each external device having the initiator attribute. As one mode of the weighting control, the initiator command for the external device is distributed to the core 32A having fewer target commands stored in the corresponding virtual target command reception queue 64, and is stored in the virtual initiator command transmission queue 61 associated with the core 32A. Accordingly, frequency and time at which the initiator processing and the target processing are simultaneously performed are reduced, and a decrease in the initiator performance due to simultaneous execution of the initiator processing and the target processing is prevented.

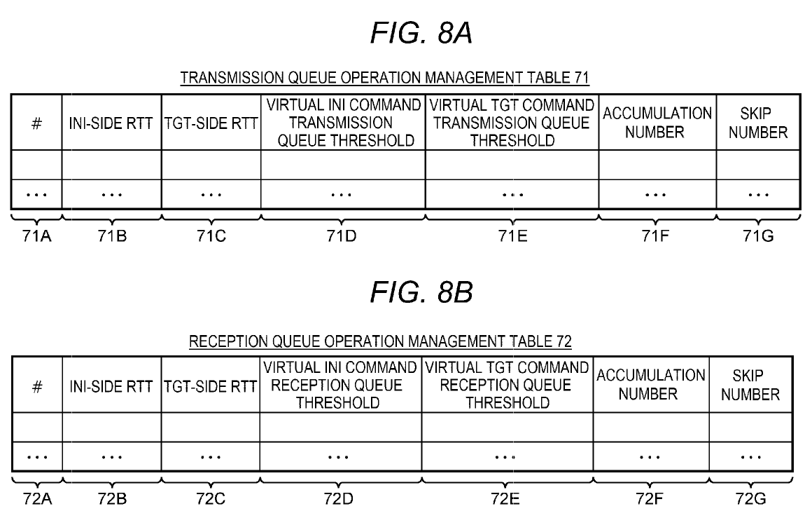

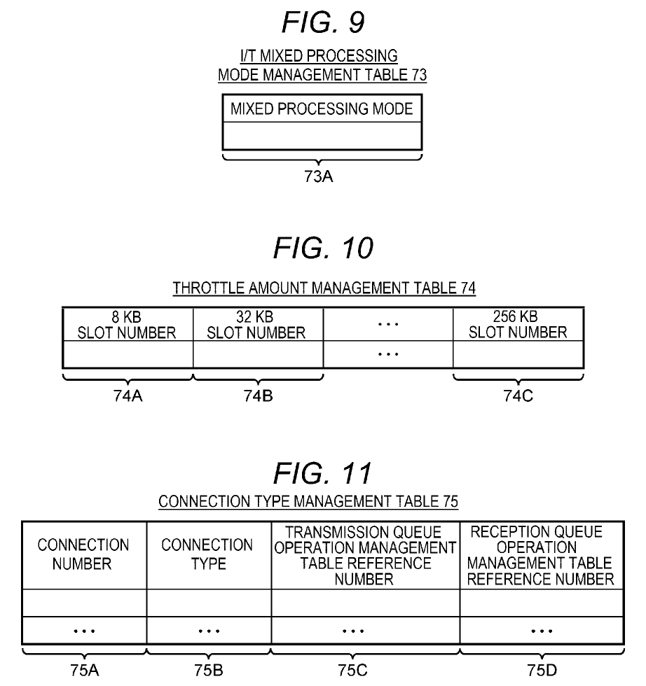

In order to achieve the aggregation port performance stabilization function according to the present embodiment as described above, the memory 23 (FIG. 2) of the network interface 13 stores the performance ratio management table 70 as illustrated in FIG. 7, a transmission queue operation management table 71 as illustrated in FIG. 8A, a reception queue operation management table 72 as illustrated in FIG. 8B, an I/T mixed processing mode management table 73 as illustrated in FIG. 9, a throttle amount management table 74 as illustrated in FIG. 10, and a connection type management table 75 as illustrated in FIG. 11.

The performance ratio management table 70 is a table used to hold the expected values for the initiator performance and the target performance of the network interface 13, which are weights of the above-described weighting control, set in advance for the network interface 13 by a user or the like using a predetermined setting screen or the like.

As illustrated in FIG. 7, the performance ratio management table 70 includes an initiator performance column 70A and a target performance column 70B. The initiator performance column 70A stores the expected value for the initiator performance set for the corresponding network interface 13, and the target performance column 70B stores the expected value for the target performance set for the network interface 13.

It should be noted that as the expected values for the initiator performance and the target performance, for example, numerical values such as "1 GB/s" for the initiator performance and "2 GB/s" for the target performance may be individually set, and a combination of the expected values for the initiator performance and the target performance that can be set may be selected by a pulldown method.

The expected values for the initiator performance and the target performance may not be specific numerical values, and may represent a range such as "high", "medium", or "low". In this case, the expected values for the initiator performance and the target performance may be individually set such that the initiator performance is "medium" and the target characteristic is "high", or a combination of the expected values for the initiator performance and the target performance that can be set may be selected by a pulldown method.

Further, the expected values for the initiator performance and the target performance may be represented by a ratio between a magnitude of the expected value for the initiator performance and a magnitude of the expected value for the target performance. In this case, the expected values for the initiator performance and the target performance may be individually set such that the initiator performance is "1" and the target performance is "2", or a combination of the expected values for the initiator performance and the target performance that can be set may be selected by a pulldown method.

The transmission queue operation management table 71 is a table used to manage combination patterns of various settings for the virtual initiator command transmission queue 61 and the virtual target command transmission queue 63 created in advance by the user or the like. It should be noted that in FIG. 8A, "INI" means initiator, "TGT" means target, and "RTT" means round trip time. The same applies to the following description.

As illustrated in FIG. 8A, the transmission queue operation management table 71 includes a number column 71A, an initiator-side round trip time column 71B, a target-side round trip time column 71C, a virtual initiator command transmission queue threshold column 71D, a virtual target command transmission queue threshold column 71E, an accumulation number column 71F, and a skip number column 71G. The transmission queue operation management table 71 has entries (rows) for each combination pattern of various settings created by the user or the like (hereinafter referred to as a transmission queue operation setting combination pattern), and one entry corresponds to one transmission queue operation setting combination pattern.

The number column 71A stores an identification number unique to the transmission queue operation setting combination pattern assigned to the corresponding transmission queue operation setting combination pattern. The initiator-side round trip time column 71B stores a round trip time (time required from a start of a network request to acquisition of a response) with the corresponding data transfer destination storage system 3, and the target-side round trip time column 71C stores a round trip time with the server system 2.

It should be noted that as the round trip time set in the initiator-side round trip time column 71B or the target-side round trip time column 71C, a round trip time acquired by transmitting a Ping in the network interface 13 may be used, or a time measured when a TCP connection is established may be used, in addition to a value manually measured by the user or the like.

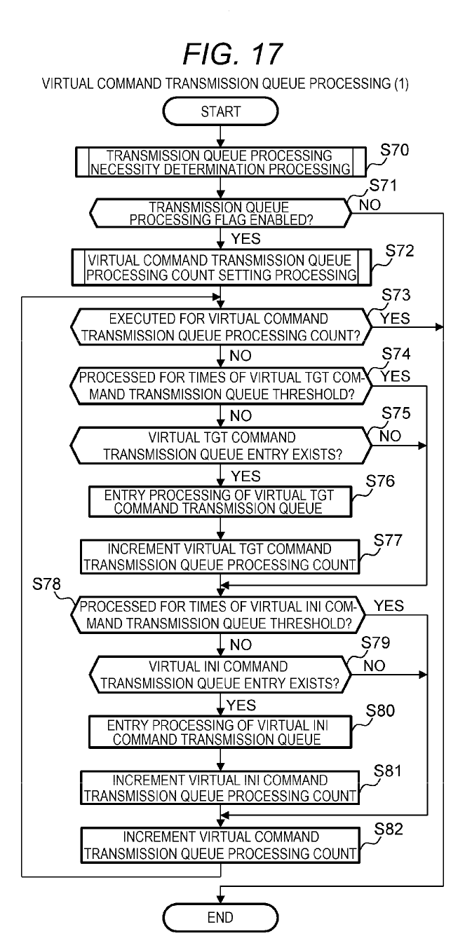

The virtual initiator command transmission queue threshold column 71D stores the maximum number of initiator commands (hereinafter, referred to as a virtual initiator command transmission queue threshold) that can be processed in one virtual command transmission queue processing, which will be described below with reference to FIG. 17, among the initiator commands stored in the virtual initiator command transmission queue 61 when the round trip time with the data transfer destination storage system 3 is a value stored in the initiator-side round trip time column 71B of the same row.

Similarly, when the round trip time with the server system 2 is a value stored in the target-side round trip time column 71C of the same row, the virtual target command transmission queue threshold column 71E stores the maximum number of target commands (hereinafter, referred to as a virtual target command transmission queue threshold) that can be processed in one virtual command transmission queue processing (FIG. 17), among the target commands stored in the virtual target command transmission queue 63.

It should be noted that one of the virtual initiator command transmission queue threshold and the virtual target command transmission queue threshold is automatically set when the other is set by the user or the like according to the ratio between the initiator performance and the target performance set in the performance ratio management table 70 (FIG. 7).

Further, the accumulation number column 71F stores a numerical value (hereinafter, referred to as an accumulation number) indicating how many initiator commands or target commands must be accumulated in the virtual initiator command transmission queue 61 or the virtual target command transmission queue 63 before the virtual command transmission queue processing (FIG. 17) is executed. When "0" is stored in the accumulation number column 71F as the accumulation number, it means that the virtual command transmission queue processing should be executed even when no initiator commands and target commands are accumulated in the virtual initiator command transmission queue 61 and the virtual target command transmission queue 63.

Further, the skip number column 71G stores the maximum count the virtual command transmission queue processing can be skipped (hereinafter referred to as a skip number) when initiator commands and target commands are not accumulated in the virtual initiator command transmission queue 61 and the virtual target command transmission queue 63 by the accumulation number stored in the accumulation number column 71F of the same row.

Since the virtual command transmission queue processing is repeatedly executed as described below, the core 32A attempts to repeatedly execute the virtual command transmission queue processing even if the initiator command or the target command is not accumulated in the virtual initiator command transmission queue 61 or the virtual target command transmission queue 63. Therefore, when the initiator commands or target commands are not stored in the virtual initiator command transmission queue 61 or the virtual target command transmission queue 63 by the accumulation number, the skip number is set to prevent the initiator commands or target commands stored in the virtual initiator command transmission queue 61 or the virtual target command transmission queue 63 from timing out.

On the other hand, the reception queue operation management table 72 is a table used to manage combination patterns of various settings for the virtual initiator command reception queue 62 and the virtual target command reception queue 64 created in advance by the user or the like.

As illustrated in FIG. 8B, the reception queue operation management table 72 includes a number column 72A, an initiator-side round trip time column 72B, a target-side round trip time column 72C, a virtual initiator command reception queue threshold column 72D, a virtual target command reception queue threshold column 72E, an accumulation number column 72F, and a skip number column 72G. The reception queue operation management table 72 has entries (rows) for each combination pattern of various settings created by the user or the like (hereinafter referred to as a reception queue operation setting combination pattern), and one entry corresponds to one reception queue operation setting combination pattern.

The number column 72A stores an identification number unique to the reception queue operation setting combination pattern assigned to the corresponding reception queue operation setting combination pattern. The initiator-side round trip time column 72B stores a round trip time with the corresponding data transfer destination storage system 3, and the target-side round trip time column 72C stores a round trip time with the corresponding server system 2.

It should be noted that as the round trip time set in the initiator-side round trip time column 72B or the target-side round trip time column 72C, a round trip time acquired after transmitting a Ping in the network interface 13 may be used, or a time measured when a TCP connection is established may be used, in addition to a value manually measured by the user or the like.

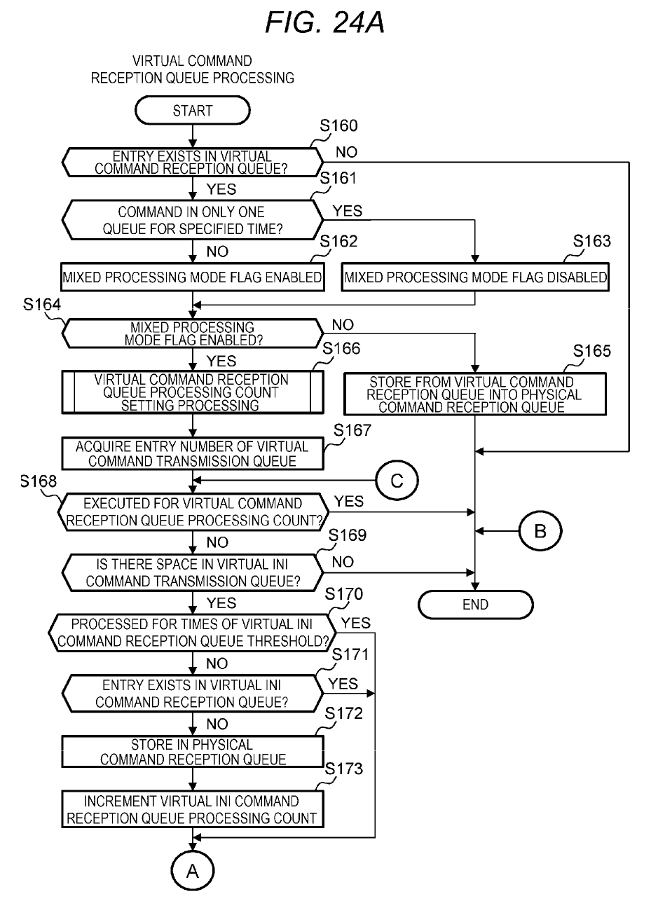

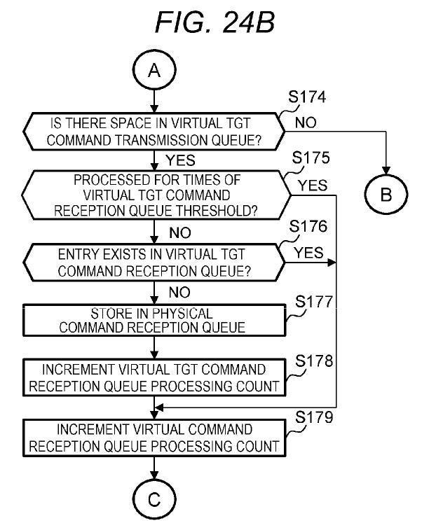

The virtual initiator command reception queue threshold column 72D stores the maximum number of initiator commands (hereinafter, referred to as a virtual initiator command reception queue threshold) that can be transferred to the interface-side physical command reception queue 66 (FIG. 6) in the same physical port-corresponding command queue group 69 in one virtual command reception queue processing, which will be described below with reference to FIGS. 24A and 24B, among the initiator commands stored in the virtual initiator command reception queue 62 in a case where the round trip time with the data transfer destination storage system 3 is a value stored in the initiator-side round trip time column 72B of the same row.

Similarly, the virtual target command reception queue threshold column 72E stores the maximum number of target commands (hereinafter, referred to as a virtual target command reception queue threshold) that can be transferred to the interface-side physical command reception queue 66 in one virtual command reception queue processing (FIGS. 24A and 24B) among the target commands stored in the virtual target command reception queue 64 when the round trip time with the server system 2 is a value stored in the target-side round trip time column 72C of the same row.

It should be noted that one of the virtual initiator command reception queue threshold and the virtual target command reception queue threshold is automatically set when the other is set by the user or the like according to the ratio between the initiator performance and the target performance set in the performance ratio management table 70 (FIG. 7).

Further, the accumulation number column 72F stores a numerical value (accumulation number) indicating how many initiator commands or target commands must be accumulated in the virtual initiator command reception queue 62 or the virtual target command reception queue 64 before the virtual command reception queue processing (FIGS. 24A and 24B) is executed. It should be noted that when "0" is stored in the accumulation number column 72F as the accumulation number, it means that the virtual command reception queue processing should be executed even when no initiator commands and target commands are accumulated in the virtual initiator command reception queue 62 and the virtual target command reception queue 64.

Further, the skip number column 72G stores a numerical value (skip number) representing the maximum count the virtual command reception queue processing can be skipped when initiator commands and target commands are not accumulated in the virtual initiator command reception queue 62 and the virtual target command reception queue 64 by the accumulation number.

Since the virtual command reception queue processing is repeatedly executed as described below, the core 32A attempts to repeatedly execute the virtual command reception queue processing even if the initiator command or the target command is not accumulated in the virtual initiator command reception queue 62 or the virtual target command reception queue 64. Therefore, when the initiator commands or target commands are not stored in the virtual initiator command reception queue 62 or the virtual target command reception queue 64 by the accumulation number, the skip number is set to prevent the initiator commands or target commands accumulated in the virtual initiator command reception queue 62 or the virtual target command reception queue 64 from timing out.

On the other hand, the I/T mixed processing mode management table 73 is a table used to manage a preliminary setting as to whether to execute the control by the aggregation port performance stabilization function described above when the initiator command is stored in at least one of the virtual initiator command transmission queue 61 and the virtual initiator command reception queue 62 and the target command is stored in at least one of the virtual target command transmission queue 63 and the virtual target command reception queue 64 (that is, when the initiator commands and the target commands are mixed).

In practice, in the information processing system 1 of the present embodiment, the user or the like can set in advance whether to enable (set to an ON state) a processing mode (hereinafter, referred to as an I/T mixed processing mode) for executing control by the aggregation port performance stabilization function. As illustrated in FIG. 9, the I/T mixed processing mode management table 73 includes a mixed processing mode column 73A, and a flag for I/T mixed processing mode management (hereinafter referred to as a mixed processing mode flag) is stored in the mixed processing mode column 73A.

When the I/T mixed processing mode is enabled (set to an ON state), the mixed processing mode flag stored in the mixed processing mode column 73A of the I/T mixed processing mode management table 73 is set to "1", and when the I/T mixed processing mode is set to an OFF state, the mixed processing mode flag is set to "0".

The throttle amount management table 74 is a table used to manage an upper limit number of use for each size of the data buffer used in the throttle mode described above, and as illustrated in FIG. 10, includes a slot number column 74A corresponding to each size of the plurality of data buffers.

Each slot number column 74A stores the number of data buffers of the corresponding size that can be used at the same time (hereinafter referred to as a slot number). The slot number is set in advance by the user or the like, and the set slot number is stored in each slot number column 74A.

The connection type management table 75 is a table used to manage a connection type (initiator or target) of each connection established between each core 32A of the host network interface 13 and the server system 2 or the data transfer destination storage system 3, and the transmission queue operation setting combination pattern and the reception queue operation setting combination pattern to be applied to the connection.

As illustrated in FIG. 11, the connection type management table 75 includes a connection number column 75A, a connection type column 75B, a transmission queue operation management table reference number column 75C, and a reception queue operation management table reference number column 75D. In the connection type management table 75, one row corresponds to one connection established between one core 32A of the host network interface 13 and the server system 2 or the data transfer destination storage system 3.

The connection number column 75A stores an identification number (connection number) unique to the connection assigned to the corresponding connection, and the connection type column 75B stores the connection type of the host network interface 13 in the connection.

The transmission queue operation management table reference number column 75C stores the identification number of the transmission queue operation setting combination pattern to be applied to the corresponding connection among the transmission queue operation setting combination patterns registered in the transmission queue operation management table 71 described above with reference to FIG. 8A.

Similarly, the reception queue operation management table reference number column 75D stores an identification number of a reception queue operation setting combination pattern to be applied to the corresponding connection among reception queue operation setting combination patterns registered in the reception queue operation management table 72 described above with reference to FIG. 8B.

It should be noted that although FIG. 11 illustrates a case where the connection types are classified into two types of initiator and target, the connection types may be further classified in detail by adding elements other than the initiator and the target. For example, the connection type may be classified into a plurality of stages of "high-speed delay" and "low-speed delay" according to the round trip time in the connection, such as "initiator high-speed delay 1", "initiator high-speed delay 2", "target low-speed delay 1", and "target low-speed delay 2".

The connection type management table 75 is used when weights of an initiator processing amount and a target processing amount are changed by determining whether the host network interface 13 is the initiator or the target for each connection and adjusting the amount of communication packets fetched from the packet buffer in the storage controller 10 and processed. The connection type management table 75 is also used to control the fetching amount of the packets from the packet buffer so that the interface-side physical command transmission queue 65 described above with reference to FIG. 6 is not clogged.

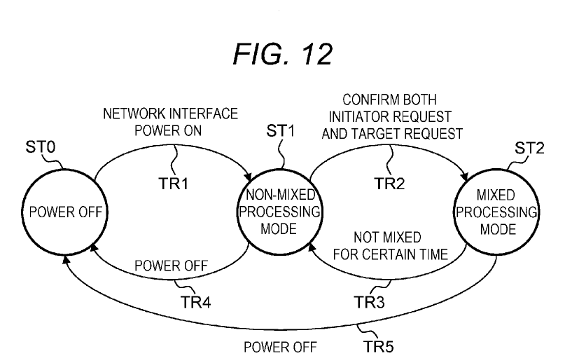

FIG. 12 illustrates a state transition of each core 32A of the network interface 13 related to the above-described I/T mixed processing mode. As illustrated in FIG. 12, when the network interface 13 is powered on from a power-off state (ST0), the core 32A is activated in a normal processing mode (hereinafter, referred to as an I/T non-mixed processing mode) ST1 that is not the I/T mixed processing mode (TR1).

In the I/T non-mixed processing mode ST1, control for preventing the initiator performance and the target performance of the storage controller 10 from being lower than expected performance is not performed. In the I/T non-mixed processing mode ST1, the core 32A monitors the virtual initiator command reception queue 62 and the virtual initiator command transmission queue 61, and the virtual target command reception queue 64 and the virtual target command transmission queue 63 in the same physical port-corresponding command queue group 69 (FIG. 6).

Then, if the initiator command is stored in at least one of the virtual initiator command reception queue 62 and the virtual initiator command transmission queue 61 and the target command is stored in at least one of the virtual target command transmission queue 63 and the virtual target command reception queue 64, the core 32A transitions the processing mode to the I/T mixed processing mode ST2 (TR2) and executes the I/T mixed processing described above.

The core 32A that has switched the processing mode to the I/T mixed processing mode ST2 continuously monitors the virtual initiator command transmission queue 61 and the virtual initiator command reception queue 62, and the virtual target command transmission queue 63 and the virtual target command reception queue 64 in the same physical port-corresponding command queue group 69.

If a state in which the target command is stored in at least one of the virtual target command transmission queue 63 and the virtual target command reception queue 64 and the initiator command is stored in at least one of the virtual initiator command transmission queue 61 and the virtual initiator command reception queue 62 does not occur for a certain period of time, the core 32A transitions the processing mode to the I/T non-mixed processing mode ST1 (TR3). It should be noted that the "certain period of time" in this case may be set by the user or the like.

Thereafter, the core 32A operates while appropriately switching the processing mode between the I/T non-mixed processing mode ST1 and the I/T mixed processing mode ST2 according to a storage situation of the initiator command in the virtual initiator command transmission queue 61 and the virtual initiator command reception queue 62 and a storage situation of the target command in the virtual target command transmission queue 63 and the virtual target command reception queue 64.

Then, when the power of the network interface 13 is eventually turned off, the core 32A ends the operation (TR4 and TR5).

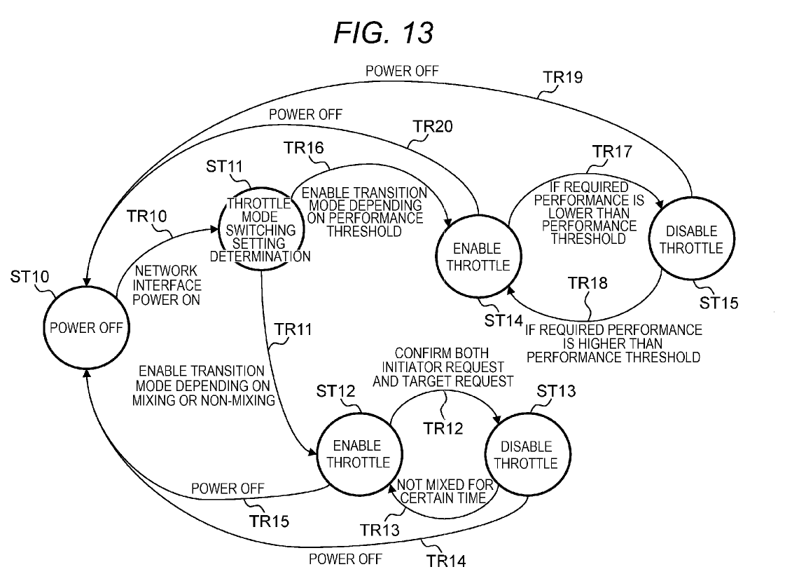

On the other hand, FIG. 13 illustrates a state transition of each core 32A related to the above-described throttle mode. As illustrated in FIG. 13, when the network interface 13 is powered on from the power-off state (ST10), the core 32A is activated in a switching setting determination state ST11 (ST10).

In the switching setting determination state ST11, the core 32A determines, as a switching setting of the throttle mode, either a first switching setting for switching between enabling and disabling of the throttle mode according to an accumulation state of the initiator command and the target command or a second switching setting for switching between enabling and disabling of the throttle mode according to the performance of the host network interface 13 in the physical port 60 is set in advance.

If the core 32A determines that the first switching setting is set in advance, the core 32A transitions to a state ST12 in which the throttle mode is enabled (TR11).

If the initiator command is stored in at least one of the virtual initiator command transmission queue 61 and the virtual initiator command reception queue 62 and the target command is stored in at least one of the virtual target command transmission queue 63 and the virtual target command reception queue 64, the core 32A transitions to a state ST13 in which the throttle mode is disabled (TR12).

Further, if the initiator command has been stored in at least one of the virtual initiator command transmission queue 61 and the virtual initiator command reception queue 62 and the target command has not been stored in at least one of the virtual target command transmission queue 63 and the virtual target command reception queue 64 for a certain period of time, the core 32A transitions from the state ST13 to a state ST12 in which the throttle mode is enabled (TR13).

Thereafter, the core 32A operates while appropriately switching the throttle mode between enabling and disabling according to the storage situation of the initiator command in the virtual initiator command transmission queue 61 and the virtual initiator command reception queue 62 and the storage situation of the target command in the virtual target command transmission queue 63 and the virtual target command reception queue 64.

Then, when the power of the network interface 13 is eventually turned off, the core 32A ends the operation (TR14 and TR15).

On the other hand, if it is determined that the second throttle mode switching setting is set as the switching setting in the switching setting determination state ST11, the core 32A transitions to a state ST14 in which the throttle mode is enabled (TR16).

Further, the core 32A monitors network performance in the corresponding physical port 60 of the host network interface 13, and transitions to a state ST15 in which the throttle mode is disabled if the network performance becomes lower than a performance threshold (hereinafter, referred to as a network performance threshold) set in advance according to memory effective band performance of the memory 23 (TR17).

Further, if the network performance in the corresponding physical port 60 of the host network interface 13 becomes equal to or higher than the above-described network performance threshold, the core 32A returns from the state ST15 to the state ST14 in which the throttle mode is enabled (TR18).

Thereafter, the core 32A operates while appropriately switching the throttle mode between enabling and disabling according to the network performance in the corresponding physical port 60 of the host network interface 13.

Then, when the power of the network interface 13 is eventually turned off, the core 32A ends the operation (TR19 and TR20).

### Various Kinds of Processing Related to Aggregation Port Performance Stabilization Function

Next, flows of various kinds of processing executed in relation to the aggregation port performance stabilization function according to the present embodiment will be described.

### Flow of Network Interface Initialization Processing

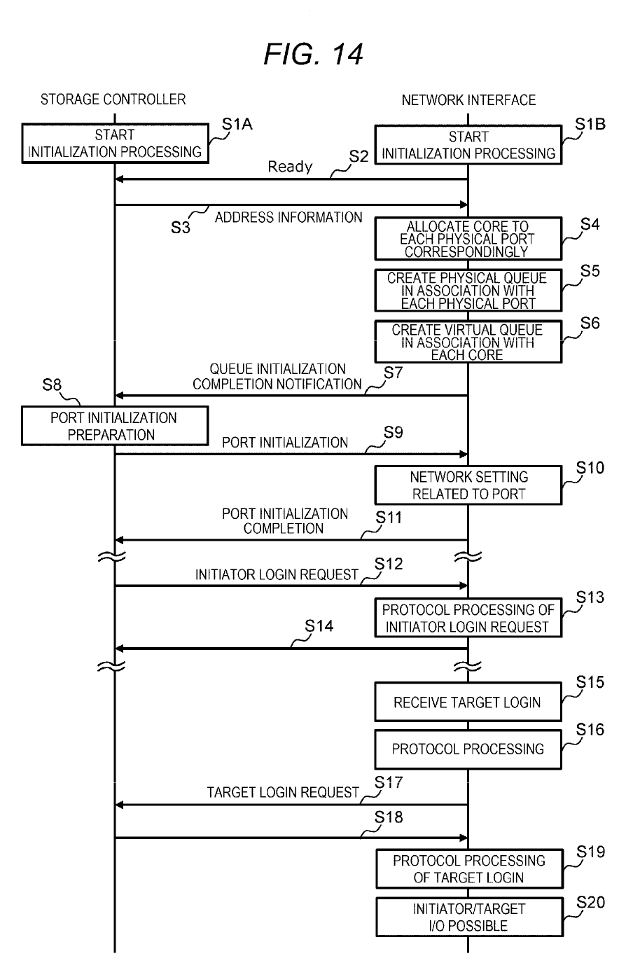

FIG. 14 illustrates a flow of a series of processing of initializing the network interface 13 mounted on the storage controller 10 (hereinafter referred to as network interface initialization processing).

When the storage device 7 (FIG. 1) is powered on or the network interface 13 is connected to the storage controller 10, the storage controller 10 and the network interface 13 start the network interface initialization processing (S1A and S1B).

Then, when preparation for initialization is completed in the network interface 13, a core (hereinafter, referred to as a representative core) 32A determined in advance as a representative among the cores 32A of the network interface 13 executes the initialization processing program 50 (FIG. 3) and transmits a Ready notification indicating that the preparation for initialization is completed to the storage controller (S2).

It should be noted that the Ready notification from the network interface 13 may be sent to the storage controller 10 by updating a specific register using a Configuration space of the PCIe, may be sent by using a Status register, or may be sent by raising an interruption.

The storage controller 10 that has acquired the Ready notification sets necessary address information such as addresses on the memories of the host-side physical command transmission queue 67 and the host-side physical command reception queue 68 in the network interface 13 using the PCIe Configuration space or the Base Address Registers (BAR) (S3).

The representative core 32A that has received a command or the like (here, address information) executes a core allocation control program 48 (FIG. 3) to assign each core 32A in the host network interface 13 to any one of the physical ports 60 (FIG. 6) (S4). By executing the initialization processing program 50 (FIG. 3), the representative core 32A creates the interface-side physical command transmission queue 65 and the interface-side physical command reception queue 66 on the memory 23 (FIG. 2) in association with the respective physical ports 60, and associates the interface-side physical command transmission queue 65 and the interface-side physical command reception queue 66 with the host-side physical command transmission queue 67 and the host-side physical command reception queue 68, respectively, based on the address information acquired in step S3. Addresses of the Head and the Tail of each queue are also associated (S5).

It should be noted that an actual state of the command stored in the interface-side physical command transmission queue 65 or the interface-side physical command reception queue 66 may not be on the network interface 13 side, and the actual state of the command may be in a host-side physical command transmission queue 67 or a host-side physical command reception queue 68 on the storage controller side, and the command may be directly transferred to the virtual transmission queue or the virtual reception queue therefrom. For example, if there is a command in the host-side physical command transmission queue 67, there may be a buffer with a capacity corresponding to the maximum number of transferred commands that are temporarily stored when the commands are subjected to DMA to the network interface 13, or there may be an interface-side physical command transmission queue 65, and a method may be used in which a content of the command subjected to DMA is viewed and distributed to the corresponding virtual transmission queue. When a command of the virtual reception queue of the network interface 13 is transmitted to the host-side physical command reception queue 68, the interface-side physical command reception queue 66 is used only for managing a position to which the command is transmitted by matching positions of the Head and the Tail of the host-side command reception queue 68, and the command stored in the virtual reception queue may be directly transferred to the host-side physical command reception queue 68 by DMA.

Thereafter, based on the initialization processing program 50, each core 32A creates the virtual initiator command transmission queue 61 and the virtual target command transmission queue 63, and the virtual initiator command reception queue 62 and the virtual target command reception queue 64 on the memory 23 in association with itself (S6). However, the representative core 32A may create the virtual initiator command transmission queue 61 and the virtual target command transmission queue 63, and the virtual initiator command reception queue 62 and the virtual target command reception queue 64 on the memory 23 in association with each core 32A.

When all the cores 32A have created the virtual initiator command transmission queue 61, the virtual target command transmission queue 63, the virtual initiator command reception queue 62, and the virtual target command reception queue 64, the representative core 32A transmits a queue initialization completion notification to the storage controller 10 based on the initialization processing program 50 in the same manner as in step S2 (S7).

The storage controller 10 that has received the queue initialization completion notification executes port initialization preparation for allocating a network IP address to each physical port 60 of the network interface 13 (S8), and then transmits a port initialization command including the network IP address allocated to each physical port 60 to the representative core 32A (S9).

It should be noted that the transmission of the command or the like from the storage controller 10 to the network interface 13 in step S9 is performed by storing the command or the like (here, address information) in the Tail area of the host-side physical command transmission queue 67 and updating the Tail of the host-side physical command transmission queue 67.

In response to this update, any one of the cores 32A that executes the host queue control program 44 in the network interface 13 fetches the command or the like from the host-side physical command transmission queue 67 using the DMA controller 34 based on the DMA control program 47, and stores the fetched command or the like in the Tail area of the interface-side physical command transmission queue 65 of the network interface 13 using the DMA controller 34 based on the DMA control program 47. The core 32A updates the Tail of the interface-side physical command transmission queue 65.

In response to this update, any one of the cores 32A that executes the host queue control program 44 fetches the command or the like stored in the interface-side physical command transmission queue 65, and distributes the fetched command or the like to the virtual initiator command transmission queue 61 or the virtual target command transmission queue 63 associated with the corresponding core (here, the representative core) 32A.

Then, the representative core 32A fetches the command or the like from the virtual initiator command transmission queue 61 or the virtual target command transmission queue 63. Accordingly, the core 32A of the network interface 13 can receive the command or the like from the storage controller 10.

The representative core 32A that has received the port initialization command performs various network settings such as setting each received network IP address to an IP address of the corresponding physical port 60 based on the initialization processing program 50 (S10). When the network setting is completed, the representative core 32A transmits a port initialization completion notification indicating that the initialization of the physical port 60 is completed to the storage controller 10 as in step S2 (S11). As above, the initialization of the physical port 60 is completed.

It should be noted that the transmission of the command or the like from the network interface 13 to the storage controller 10 in step S11 is performed by the core (here, the representative core) 32A storing the command or the notification in the virtual initiator command reception queue 62 or the virtual target command reception queue 64 associated with itself.

The command or the like stored in the virtual initiator command reception queue 62 or the virtual target command reception queue 64 is then read from the virtual initiator command reception queue 62 or the virtual target command reception queue 64 by any one of the cores 32A executing the host queue control program 44, and stored in the Tail area of the interface-side physical command reception queue 66. In this case, the core 32A updates the Tail of the interface-side physical command reception queue 66.

For example, the cores 32A periodically compete for a lock, and confirm whether a command or the like is stored in each virtual initiator command reception queue 62 and each virtual target command reception queue 64, and when a command or the like is stored in any one of the virtual initiator command reception queues 62 and the virtual target command reception queues 64, this processing may be executed by the core 32A that has acquired the lock. A core 32A may be provided that is dedicated to confirm whether a command or the like is stored in the virtual initiator command reception queue 62 and the virtual target command reception queue 64, and to fetch the command or the like. Hereinafter, the same applies to the case of "any one of the cores 32A".

In response to the update of the Tail of the interface-side physical command reception queue 66, any one of the cores 32A fetches the command or the like stored in the interface-side physical command reception queue 66 based on the host queue control program 44, and stores the fetched command or the like in the Tail area of the host-side physical command reception queue 68 of the storage controller 10 using the DMA controller 34 based on the DMA control program 47, as described above. The core 32A updates the Tail of the host-side physical command reception queue 68.

The storage controller 10 receives the update of Tail of the host-side physical command reception queue 68 and fetches the command or the like from the host-side physical command reception queue 68. Accordingly, the storage controller 10 can receive a command or the like from the network interface 13. It should be noted that the command in the virtual target command reception queue 64 or the virtual initiator command reception queue 62 may be directly DMA-transferred to the host-side physical command reception queue 68 without being copied to the interface-side physical command reception queue 66.

Thereafter, as in step S9, the storage controller 10 transmits an initiator login request command for requesting login to the data transfer destination storage system 3 to the network interface 13 as in step S9 (S12). Then, the initiator login request command is distributed to any one of the cores 32A.

The core 32A to which the initiator login request command is distributed (hereinafter, referred to as an in-charge core) executes the protocol processing program 43 to execute protocol processing of encapsulating the initiator login request command into a communication packet conforming to the network protocol, and transmits the encapsulated initiator login request command to the corresponding data transfer destination storage system 3 (S13). Thereafter, when the login to the data transfer destination storage system 3 is completed, the in-charge core 32A transmits a login completion notification to the storage controller 10 based on the host queue control program 44 in the same manner as in step S2 (S14).

On the other hand, when the core 32A receives the communication packet in which the login request command is stored from the server system 2 (S15), the core 32A executes the protocol processing of extracting the login request command from the communication packet by executing the protocol processing program 43 (S16), and transmits the extracted login request command to the storage controller 10 based on the host queue control program 44 in the same manner as in step S11 (S17).

Then, when a login response to the login request is provided from the storage controller 10 in the same manner as in step S3 (S18), the core 32A executes the protocol processing program 43 to execute the protocol processing of encapsulating the login response into a communication packet conforming to the network protocol, and transmits the encapsulated login response to the server system 2 (S19).

As described above, the core 32A can thereafter communicate with the data transfer destination storage system 3 and the server system 2 as an initiator and a target (S20).

### Flow of Initiator Command Processing

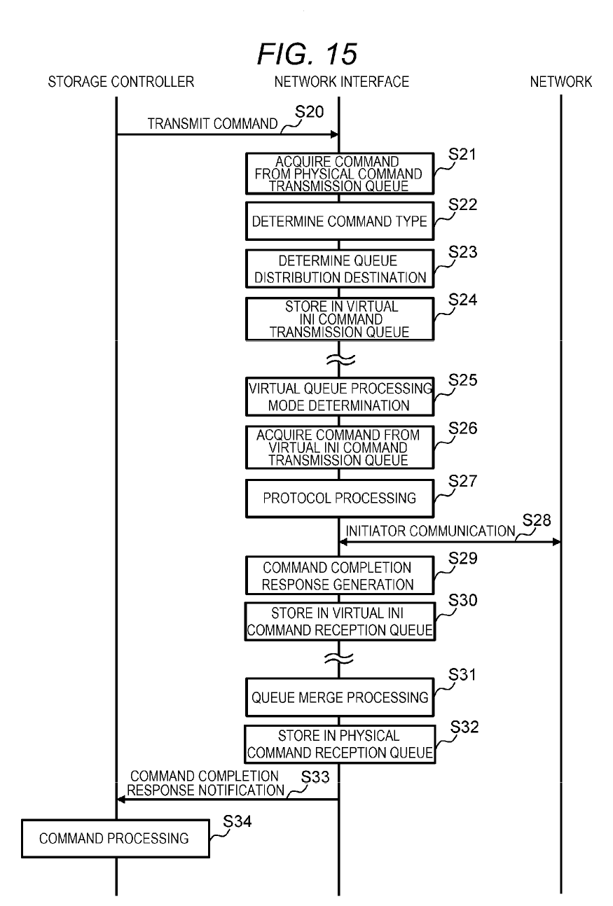

FIG. 15 illustrates a flow of a series of processing (hereinafter referred to as initiator command processing) executed when the storage controller 10 transmits some command (initiator command) such as a read command or a write command to the data transfer destination storage system 3 after the network interface initialization processing described above with reference to FIG. 14.

When transmitting some command (initiator command) to the data transfer destination storage system 3, the storage controller 10 first transmits the initiator command to the network interface 13 as in step S9 of FIG. 14 (S20). Accordingly, the initiator command is stored in the interface-side physical command transmission queue 65 of the network interface 13.

Then, the initiator command stored in the interface-side physical command transmission queue 65 is fetched from the interface-side physical command transmission queue 65 by any one of the cores 32A that executes the host queue control program 44 in the same physical port-corresponding command queue group 69 (S21).

The core 32A that has fetched the command from the interface-side physical command transmission queue 65 in step S21 determines whether a type of the command fetched in step S21 is an initiator command or a target command based on the host queue control program 44 (S22). Here, the type of the command is determined to be an initiator command.

Next, based on the host queue control program 44, the core 32A determines a core 32A to which the command (initiator command) acquired in step S21 is distributed (hereinafter referred to as a transmission command distribution destination core) (S23).

In the present embodiment, in the case of the initiator command, since all the cores 32A in the same physical port-corresponding command queue group 69 have established a session with each data transfer destination storage system 3 as described above, the core 32A having fewer target commands stored in the associated virtual target command transmission queue 63 is determined as the transmission command distribution destination core from among these cores 32A.

Accordingly, it is possible to reduce the time in which the initiator processing for the initiator command in the core 32A and the target processing for the target command stored in the virtual target command transmission queue 63 are simultaneously performed. However, the transmission command distribution destination core 32A may be determined from among the cores 32A in the same physical port-corresponding command queue group 69 in a round-robin manner, or may be determined in consideration of a load of each core 32A.

Thereafter, the core 32A starts the DMA control program 47 based on the host queue control program 44 and uses the DMA controller 34 to store the command in the Tail area of the virtual initiator command transmission queue 61 associated with the transmission command distribution destination core 32A determined in step S23 (S24).

On the other hand, the transmission command distribution destination core 32A executes the host queue control program 44 to determine in which processing mode of the mixed processing mode and the non-mixed processing mode described above with reference to FIG. 12 the command (initiator command) stored in the virtual initiator command transmission queue 61 thereof is to be processed (S25).

Specifically, when some target command is stored in at least one of the virtual target command transmission queue 63 and the virtual target command reception queue 64 associated with the transmission command distribution destination core 32A, the transmission command distribution destination core 32A determines that the processing should be performed in the mixed processing mode. The transmission command distribution destination core 32A determines that the processing should be performed in the non-mixed processing mode when no target command is stored in the virtual target command transmission queue 63 or the virtual target command reception queue 64 associated with the transmission command distribution destination core 32A for a latest certain time.

Then, by executing the protocol processing program 43, the transmission command distribution destination core 32A operates in the processing mode determined in step S25 and fetches the initiator command from the host virtual initiator command transmission queue 61 thereof (S26). The transmission command distribution destination core 32A executes protocol processing of encapsulating the initiator command acquired in step S26 into a communication packet (S27), and transmits the created communication packet to the data transfer destination storage system 3 (S28).

In this case, when data transfer using a buffer is necessary, the transmission command distribution destination core 32A executes the buffer control program 46 (FIG. 3) to ensure a data buffer area on the memory 23 or the cache 35. The transmission command distribution destination core 32A executes the DMA control program 47 to transfer data from the storage controller 10 to the data buffer area using the DMA controller 34, or stores the data from the storage controller 10 in the data buffer area and transfers the data from the data buffer area to the data transfer destination storage system 3 using the DMA controller 34.

Thereafter, when the transmission of the initiator command and the data is completed, the transmission command distribution destination core 32A executes the command processing program 45 to generate a command completion response notification indicating that the processing of the initiator command is completed (S29), and stores the generated command completion response notification in the Tail area of the virtual initiator command reception queue 62 thereof (S30).

Thereafter, the command completion response notification stored in the virtual initiator command reception queue 62 is fetched from the virtual initiator command reception queue 62 by any one of the cores 32A, and is merged with the target command stored in the virtual target command reception queue 64 associated with itself or the initiator command and the target command stored in the virtual initiator command reception queue 62 or the virtual target command reception queue 64 associated with another core 32A, and stored in the Tail area of the interface-side physical command reception queue 66 in the same physical port-corresponding command queue group 69 (S31 and S32). In this case, the Tail of the interface-side physical command reception queue 66 is updated.

In response to this update, the command completion response notification is fetched from the interface-side physical command reception queue 66, transmitted to the storage controller 10, and stored in the host-side physical command reception queue 68 of the storage controller 10 by any one of the cores 32A in the same manner as in step S11 of FIG. 14 (S33). In this case, the Tail area of the host-side physical command reception queue 68 is updated.

Then, the storage controller fetches the command completion response notification stored in the host-side physical command reception queue 68, and executes necessary command processing based on the fetched command completion response notification (S34). As above, this series of processing ends.

### Target Command Processing

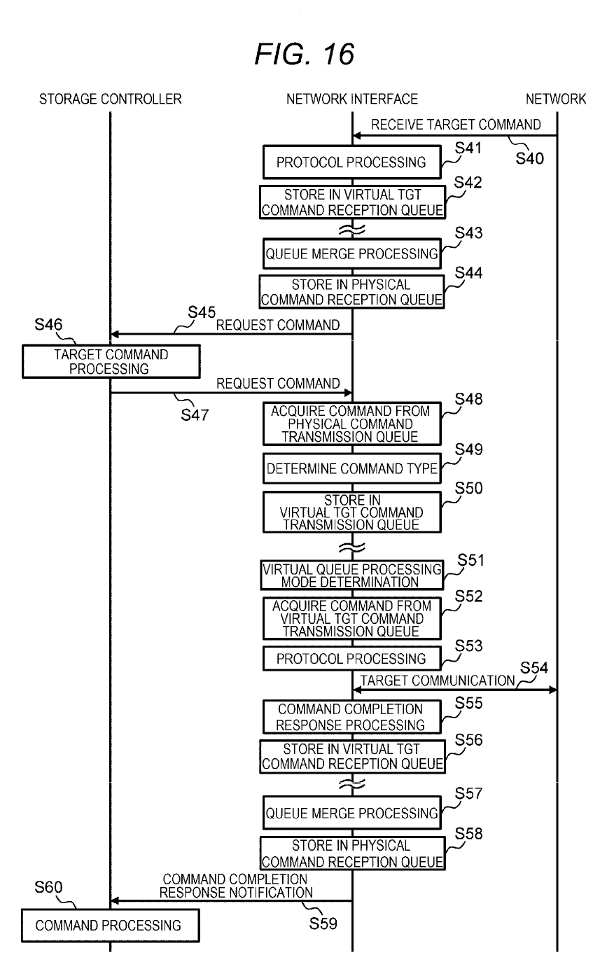

On the other hand, FIG. 16 illustrates a flow of a series of processing (hereinafter, referred to as target command processing) executed when the network controller 31 (FIG. 2) of the network interface 13 receives a communication packet storing some command (target command) such as a read command or a write command from the server system 2 (S40) after the network interface initialization processing described above with reference to FIG. 14.

The network controller 31 distributes the protocol processing of the received communication packet (received packet) to any one of the cores 32A managing connection information of the packet. Then, the core 32A to which the protocol processing is distributed (hereinafter, referred to as a reception command distribution destination core) executes the protocol processing program 43 to execute the protocol processing of extracting a target command from the communication packet (S41).

The reception command distribution destination core 32A executes the command processing program 45 to store the extracted target command in the Tail area of the virtual target command reception queue 64 associated with itself (S42).

Thereafter, the target command stored in the virtual target command reception queue 64 is read from the virtual target command reception queue 64 by any one of the cores 32A, merged with the initiator command stored in the virtual initiator command reception queue 62 associated with the core 32A or the initiator command and the target command stored in the virtual initiator command reception queue 62 or the virtual target command reception queue 64 associated with another core 32A, and stored in the Tail area of the interface-side physical command reception queue 66 in the same physical port-corresponding command queue group 69 (S43, S44). In this case, the Tail of the interface-side physical command reception queue 66 is updated.

In response to this update, any one of the cores 32A executing the host queue control program 44 transmits the target command stored in the interface-side physical command reception queue 66 to the storage controller 10 in the same manner as step S11 of FIG. 14 (S45).

Then, the storage controller 10 executes command processing corresponding to the received target command (S46), and transmits a request command such as a write data transfer request to the network interface 13 in the same manner as in step S9 of FIG. 14 (S47). As a result, the request command is stored in the Tail area of the interface-side physical command transmission queue 65 of the network interface 13, and the Tail of the interface-side physical command transmission queue 65 is updated.

In response to this update, any one of the cores 32A executing the host queue control program 44 in the same physical port-corresponding command queue group 69 fetches the command stored in the interface-side physical command transmission queue 65 (S48).

The core 32A determines whether a type of the command acquired in step S48 is an initiator command or a target command based on the host queue control program 44 (S49). Here, the type of the command is determined to be a target command.

Next, the core 32A stores the command (target command) acquired in step S48 in the virtual target command transmission queue 63 of the corresponding core 32A according to a distribution destination core number in the command using the DMA controller 34 based on the DMA control program 47 (S50). The core 32A updates the Tail of the virtual target command transmission queue 63 by executing the host queue control program 44.

Thereafter, the reception command distribution destination core 32A executes the host queue control program 44 in the same manner as in step S25 of FIG. 15, and determines in which processing mode of the mixed processing mode and the non-mixed processing mode described above with reference to FIG. 12 the command (target command) stored in the host virtual target command transmission queue 63 thereof is to be processed (S51).

Then, the reception command distribution destination core 32A operates in the processing mode determined in step S51 based on the host queue control program 44 and acquires the target command stored in the virtual target command transmission queue 63 associated with itself (S52). The reception command distribution destination core 32A executes the protocol processing program 43 to execute the protocol processing of encapsulating the target command acquired in step S51 into a communication packet conforming to the network (S53), and transmits the created communication packet to the server system 2 (S54).

In this case, when data transfer or data reception using a buffer is necessary, the reception command distribution destination core 32A executes the buffer control program 46 to ensure a data buffer on the memory 23 or the cache 35. In the case of data transfer, the reception command distribution destination core 32A executes the DMA control program 47 to transfer data from the storage controller 10 to the data buffer using the DMA controller 34, and transmits the data transferred to the data buffer to the server system 2. In the case of data reception, the reception command distribution destination core 32A stores data from the server system 2 in the data buffer, and transfers the stored data to the memory of the storage controller 10 using the DMA controller 34 based on the DMA control program 47.

Thereafter, when the transmission and reception of the command or data is completed, the reception command distribution destination core 32A executes the command processing program 45 to create a command completion response notification indicating that the processing according to the target command is completed (S55), and stores the created command completion response notification in the host virtual target command reception queue 64 thereof (S56).

Thereafter, the command completion response notification stored in the virtual target command reception queue 64 is fetched from the virtual target command reception queue 64 by any one of the cores 32A executing the host queue control program 44, merged with the initiator command or the target command stored in the virtual initiator command reception queue 62 associated with itself, or the virtual initiator command reception queue 62 or the virtual target command reception queue 64 associated with another core 32A, and stored in the interface-side physical command reception queue 66 in the same physical port-corresponding command queue group 69 (S57 and S58). In this case, the Tail of the interface-side physical command reception queue 66 is updated.

Thereafter, the command completion response notification is transferred to the storage controller 10 in the same manner as in step S9 of FIG. 14, and is stored in the host-side physical command reception queue 68 of the storage controller 10 (S59). Then, the storage controller 10 fetches the command completion response notification from the host-side physical command reception queue 68, and executes necessary command processing based on the fetched command completion response notification (S60). As above, this series of processing ends.

### Virtual Command Transmission Queue Processing

### Flow of Virtual Command Transmission Queue Processing

FIG. 17 illustrates more detailed contents of the series of processing executed by the corresponding core 32A in step S25 to step S27 of FIG. 15 and step S51 to step S53 of FIG. 16. The corresponding core 32A processes the initiator command stored in the virtual initiator command transmission queue 61 associated with itself and the target command stored in the virtual target command transmission queue 63 associated with itself according to a processing procedure illustrated in FIG. 17.

In practice, when the core 32A proceeds to step S25 in FIG. 15 or step S51 in FIG. 16, the core 32A starts the virtual command transmission queue processing, and first executes transmission queue processing necessity determination processing of determining whether the processing in step S71 and subsequent steps should be executed at the current time (S70).

As will be described later, in the transmission queue processing necessity determination processing, if it is determined that the processing of step S71 and subsequent steps should be executed at the current time, a predetermined first internal flag (hereinafter, referred to as a virtual command transmission queue processing flag) is enabled, and if it is determined that the processing of step S71 and subsequent steps should not be executed at the current time, the virtual command transmission queue processing flag is disabled.

Subsequently, the core 32A determines whether the virtual command transmission queue is enabled (S71). If a negative result is obtained in this determination, the core 32A ends the current virtual command transmission queue processing.

On the other hand, if a positive result is obtained in the determination of step S71, the core 32A executes virtual command transmission queue processing count setting processing of setting a processing count of the initiator command or the target command to be executed in the current virtual command transmission queue processing (the maximum number of the target commands or the initiator commands to be processed in the current virtual command transmission queue processing, which will be hereinafter referred to as a virtual command transmission queue processing count) among the initiator commands stored in the virtual initiator command transmission queue 61 and the target commands stored in the virtual target command transmission queue 63 (S72).

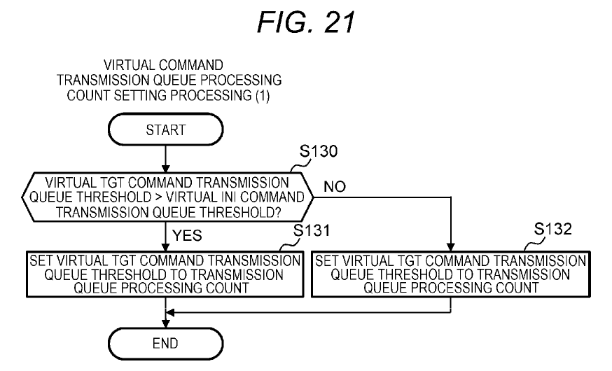

As will be described later with reference to FIG. 21, the virtual command transmission queue processing count is set to a larger one of the virtual initiator command transmission queue threshold and the virtual target command transmission queue threshold determined with reference to the transmission queue operation management table 71 based on the current round trip time between the server system 2 and the data transfer destination storage system 3.

Next, the core 32A determines whether the processing of step S74 to step S82 has been repeated the same count as the virtual command transmission queue processing count set in step S72 (S73).

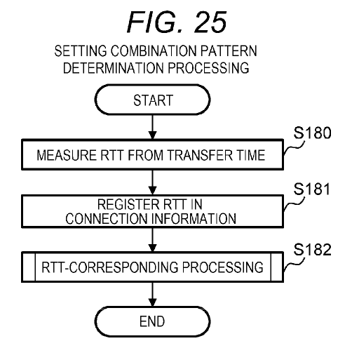

If a negative result is obtained in this determination, the core 32A selects, for example, an entry of a setting combination pattern determined in setting combination pattern determination processing described later with reference to FIG. 25 from entries of the transmission queue operation management table 71 (FIG. 8A). An entry designated by the user may be used, or a unique entry may be determined without a plurality of entries. The core 32A determines whether the processing of step S75 to step S77 has been executed the same count as the virtual target command transmission queue threshold stored in the virtual target command transmission queue threshold column 71E (FIG. 8A) of the entry selected as described above from the start of the current virtual command transmission queue processing to the present (S74). If a positive result is obtained in this determination, the core 32A proceeds to step S78.

On the other hand, if a negative result is obtained in the determination of step S74, the core 32A determines whether there is at least one entry in any virtual target command transmission queue 63 (whether at least one target command is stored in any virtual target command transmission queue 63) (S75). If a negative result is obtained in this determination, the core 32A proceeds to step S78.

On the other hand, if a positive result is obtained in the determination of step S75, the core 32A fetches one target command from any virtual target command transmission queues 63. The core 32A activates the protocol processing program 43 and executes the protocol processing described above in step S53 of FIG. 16 as entry processing for the target command fetched as described above (S76).

Further, the core 32A increments (counts up by "1") the processing count of the target command stored in the virtual target command transmission queue 63, which is counted using a counter provided corresponding to the virtual target command transmission queue 63 (S77).

Subsequently, the core 32A determines whether the processing of step S79 to step S81 has been executed the same count as the virtual initiator command transmission queue threshold stored in the virtual initiator command transmission queue threshold column 71D (FIG. 8A) of the entry selected in step S74 of the transmission queue operation management table 71 from the start of the current virtual command transmission queue processing to the present (S78). If a positive result is obtained in this determination, the core 32A proceeds to step S82.

On the other hand, if a negative result is obtained in the determination of step S78, the core 32A determines whether there is at least one entry in the virtual initiator command transmission queue 61 (whether at least one initiator command is stored in the virtual initiator command transmission queue 61) (S79). If a negative result is obtained in this determination, the core 32A proceeds to step S82.

On the other hand, if a positive result is obtained in the determination of step S79, the core 32A fetches one initiator command from the virtual initiator command transmission queue 61. The core 32A activates the protocol processing program 43 and executes the protocol processing described above in step S27 of FIG. 15 as the entry processing for the initiator command fetched as described above (S80).

Further, the core 32A increments the processing count of the initiator command stored in the virtual initiator command transmission queue 61, which is counted using a counter provided corresponding to the virtual initiator command transmission queue 61 (S81).

Next, the core 32A increments a count value of the counter that counts the processing count in step S74 to step S81 (S82), and then returns to step S73. Thereafter, the core 32A repeats the processing of step S73 to step S82 until a positive result is obtained in step S73.

By repeating this processing, the target command stored in the virtual target command transmission queue 63 is subjected to entry processing for the same count as the virtual target command transmission queue threshold at maximum and transmitted to the server system 2, and the initiator command stored in the virtual initiator command transmission queue 61 is subjected to entry processing for the same count as the virtual initiator command transmission queue threshold at maximum and transmitted to the data transfer destination storage system 3.

When a positive result is eventually obtained in step S73, the core 32A ends the virtual command transmission queue processing.

### Transmission Queue Processing Necessity Determination Processing

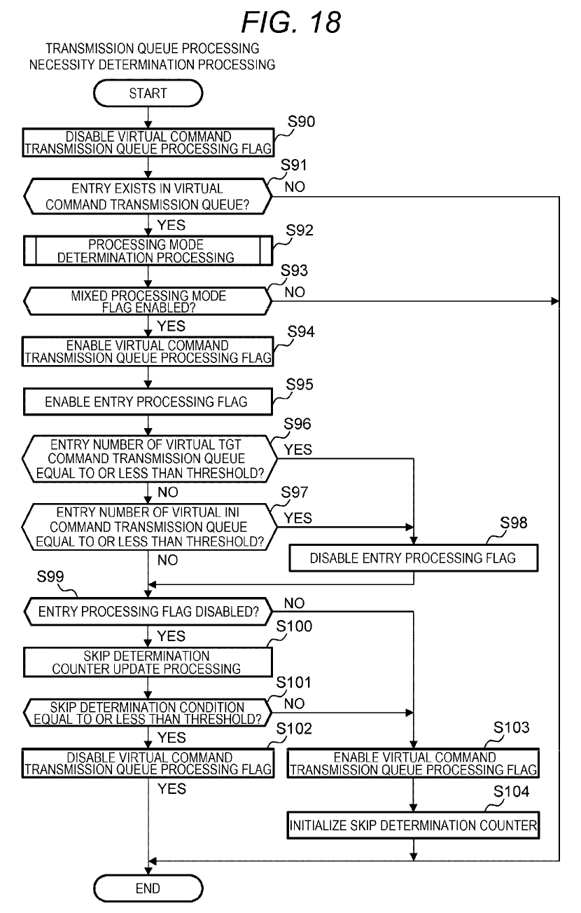

FIG. 18 illustrates a flow of the transmission queue processing necessity determination processing executed by the core 32A based on the host queue control program 44 in step S70 of the virtual command transmission queue processing described above with reference to FIG. 17. The core 32A sets the virtual command transmission queue processing count and the like in the current virtual command transmission queue processing according to the processing procedure illustrated in FIG. 18.

In practice, when the core 32A proceeds to step S70 of the virtual command transmission queue processing, the core 32A starts the transmission queue processing necessity determination processing illustrated in FIG. 18, and first disables the above-described virtual command transmission queue processing flag (S90).

Subsequently, the core 32A determines whether there is an entry (initiator command or target command) in at least one of the virtual initiator command transmission queue 61 and the virtual target command transmission queue 63 (S91). If a negative result is obtained in this determination, the core 32A ends this transmission queue processing necessity determination processing and returns to the virtual command transmission queue processing (FIG. 17).

On the other hand, if a positive result is obtained in the determination of step S91, the core 32A executes processing mode determination processing of determining a processing mode such as determining whether the processing mode of the current virtual command transmission queue processing is set to the mixed processing mode or the non-mixed processing mode and whether the throttle mode is enabled or disabled (S92).

As will be described later, in the processing mode determination processing, when it is determined that the processing mode should be the mixed processing mode, a predetermined second internal flag (hereinafter, referred to as a mixed processing mode flag) is enabled, and when it is determined that the processing mode should be the non-mixed processing mode, the mixed processing mode flag is disabled.

Subsequently, the core 32A determines whether the mixed processing mode flag is enabled (S93). If a negative result is obtained in this determination, the core 32A ends this transmission queue processing necessity determination processing and returns to the virtual command transmission queue processing.

On the other hand, if a positive result is obtained in the determination of step S93, the core 32A enables the virtual command transmission queue processing flag (S94), and enables a third internal flag (hereinafter, referred to as an entry processing flag) for managing whether the command processing should be executed in step S76 or step S80 of the virtual command transmission queue processing (S95).

Subsequently, the core 32A determines whether the entry number of the virtual target command transmission queue 63 is equal to or less than the virtual target command transmission queue threshold stored in the virtual target command transmission queue threshold column 71E of the entry corresponding to the setting combination pattern determined in the setting combination pattern determination processing described later with reference to FIG. 25, for example, in the transmission queue operation management table 71 (FIG. 8A) (S96). It should be noted that an entry designated by the user may be used, or a unique entry may be determined without a plurality of entries. If a positive result is obtained in this determination, the core 32A disables the entry processing flag (S98), and then proceeds to step S99.

On the other hand, if a negative result is obtained in the determination of step S96, the core 32A determines whether the entry number of the virtual initiator command transmission queue 61 is equal to or less than the virtual initiator command transmission queue threshold stored in the virtual initiator command transmission queue threshold column 71D of the entry described above in step S96 of the transmission queue operation management table 91 (S97). If a positive result is obtained in this determination, the core 32A disables the entry processing flag (S98), and then proceeds to step S99.

On the other hand, if a negative result is obtained in the determination of step S97, the core 32A determines whether the entry processing flag is disabled (S99). If a negative result is obtained in this determination, the core 32A enables the virtual command transmission queue processing flag (S103), and then increments a count value of a skip determination counter (not illustrated) that counts a skip count of the virtual command transmission queue processing (S100).

The core 32A determines whether the count value of the skip determination counter is equal to or less than a preset threshold (hereinafter, referred to as a skip count threshold) (S101), and then the core 32A proceeds to step S103 if a negative result is obtained in this determination. On the other hand, if a positive result is obtained in the determination of step S101, the core 32A disables the virtual command transmission queue processing flag (S102), and then ends the transmission queue processing necessity determination processing and returns to the virtual command transmission queue processing.

On the other hand, if a negative result is obtained in step S99 or step S101, the core 32A enables the virtual command transmission queue processing flag (S103), initializes the skip determination counter so as to return the count value to "0" (S104), and then ends the virtual command transmission queue processing necessity determination processing and returns to the virtual command transmission queue processing.

According to the transmission queue processing necessity determination processing described above, since the virtual command transmission queue processing flag is disabled when the entry number of the virtual target command transmission queue 63 is equal to or less than the virtual target command transmission queue threshold or when the entry number of the virtual initiator command transmission queue 61 is equal to or less than the virtual initiator command transmission queue threshold, a negative result is obtained in step S71 of the virtual command transmission queue processing, and therefore the virtual command transmission queue processing of this time is skipped.

In a case where a state in which the entry number of the virtual target command transmission queue 63 is equal to or less than the virtual target command transmission queue threshold or a state in which the entry number of the virtual initiator command transmission queue 61 is equal to or less than the virtual initiator command transmission queue threshold continues for a while and the skip count of the virtual command transmission queue processing becomes greater than the skip count threshold, the virtual command transmission queue processing flag is enabled, and therefore, a positive result is obtained in step S71 of the virtual command transmission queue processing, so that the virtual command transmission queue processing of this time is executed.

Accordingly, it is possible to prevent occurrence of a situation in which the target command stored in the virtual target command transmission queue 63 and the initiator command stored in the virtual initiator command transmission queue 61 are not transmitted for a long period of time while keeping the virtual initiator command transmission queue threshold and the virtual target command transmission queue threshold set in the transmission queue operation management table 71.

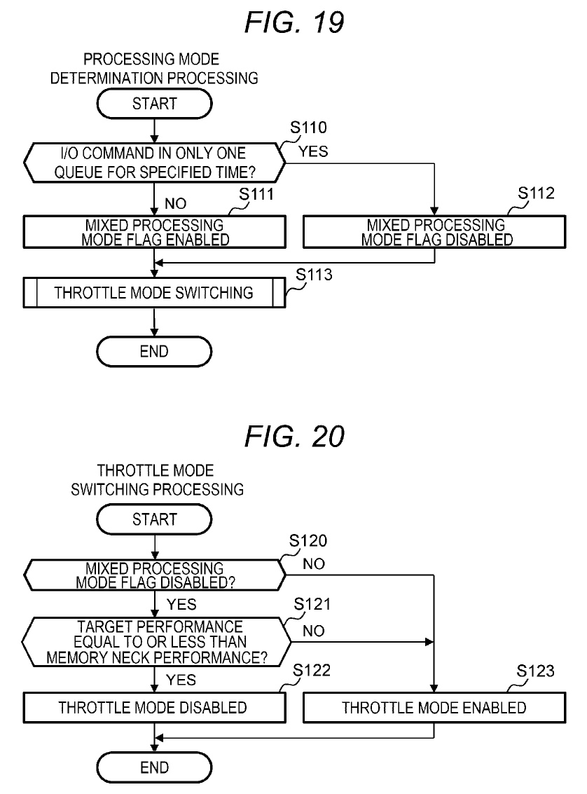

It should be noted that FIG. 19 illustrates specific processing contents of the processing mode determination processing executed by the core 32A in step S92 of the transmission queue processing necessity determination processing described above.

When the core 32A proceeds to step S92 of the transmission queue processing necessity determination processing, the core 32A starts the processing mode determination processing illustrated in FIG. 19, and first determines whether a command (initiator command or target command) is stored in only one of the virtual initiator command transmission/reception queue (virtual initiator command transmission queue 61 and virtual initiator command reception queue 62) and the virtual target command transmission/reception queue (virtual target command transmission queue 63 and virtual target command reception queue 64) within a predetermined specified period of time (S110).

If a negative result is obtained in this determination, the core 32A enables the mixed processing mode flag (S111). If a positive result is obtained in the determination of step S110, the core 32A disables the mixed processing mode flag (S112).

Thereafter, the core 32A executes throttle mode switching processing of setting the throttle mode to be enabled or disabled based on whether the target performance is equal to or lower than memory performance (S113), and then ends the processing mode determination processing.

FIG. 20 illustrates specific processing contents of the throttle mode switching processing executed by the core 32A in step S113 of the processing mode determination processing.

When the core 32A proceeds to step S113 of the processing mode determination processing, the core 32A starts the throttle mode switching processing illustrated in FIG. 20, and first determines whether the mixed processing mode flag is disabled (S120). If a positive result is obtained in this determination, the core 32A determines whether the target performance is equal to or lower than performance of a band neck point of the network interface 13 (hereinafter, for example, it is assumed that the target performance is equal to or lower than memory neck performance in the case of memory neck) (S121). Specifically, the core 32A determines whether the network performance with the server system 2 or the data transfer destination storage system 3, which is a communication destination, is lower than a band of the memory performance when reading and writing data from and to the memory 23.

If a positive result is obtained in this determination, the core 32A sets the throttle mode to be disabled (S122), and then ends this processing mode determination processing and returns to the virtual command transmission queue processing necessity determination processing. If a negative result is obtained in the determination of step S121, the core 32A sets the throttle mode to be enabled (S123), and then ends this processing mode determination processing and returns to the virtual command transmission queue processing necessity determination processing.

### Virtual Command Transmission Queue Processing Count Setting Processing

On the other hand, FIG. 21 illustrates specific processing contents of the virtual command transmission queue processing count setting processing executed by the core 32A in step S72 of the virtual command transmission queue processing described above with reference to FIG. 17.

When the core 32A proceeds to step S72 of the virtual command transmission queue processing, the core 32A starts the virtual command transmission queue processing count setting processing illustrated in FIG. 21, and first refers to the transmission queue operation management table 71 (FIG. 8A) to determine whether the virtual target command transmission queue threshold of the entry selected based on the round trip time with the server system 2 or the data transfer destination storage system 3 is larger than the virtual initiator command transmission queue threshold (S130). The virtual target command transmission queue threshold of the entry may be selected based on, for example, a round trip time with the server system 2 or the data transfer destination storage system 3.

If a positive result is obtained in this determination, the core 32A sets the value of the virtual target command transmission queue threshold as a transmission queue processing count (S131), and then ends the virtual command transmission queue processing count setting processing and returns to the virtual command transmission queue processing.

On the other hand, if a negative result is obtained in the determination of step S130, the core 32A sets the value of the virtual initiator command transmission queue threshold to the virtual command transmission queue processing count (S132), and then ends the virtual command transmission queue processing count setting processing and returns to the virtual command transmission queue processing.

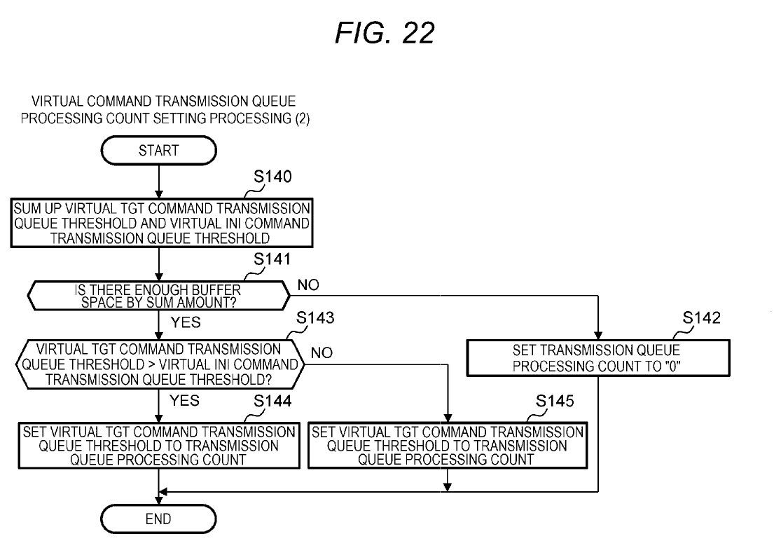

FIG. 22 illustrates another form of the virtual command transmission queue processing count setting processing. In this form, the core 32A first acquires the virtual target command transmission queue threshold and the virtual initiator command transmission queue threshold of the entry selected based on the round trip time with the server system 2 or the data transfer destination storage system 3 from the transmission queue operation management table 71, and calculates a total value of the acquired virtual target command transmission queue threshold and virtual initiator command transmission queue threshold (S140). It should be noted that the transmission queue operation management table 71 may have a plurality of entries to be selected based on the round trip time with the server system 2 or the data transfer destination storage system 3, or the user may set an entry and use the entry without using the round trip time column.

Subsequently, the core 32A determines whether there is a free area having the same capacity as the total value calculated in step S140 in the data buffer area that is defined on the memory 23 (FIG. 2) in the network interface 13 and temporarily stores data when the data is exchanged with the server system 2 or the data transfer destination storage system 3 (S141).

If a negative result is obtained in this determination, the core 32A sets the virtual command transmission queue processing count to "0" (S142), and then ends the virtual command transmission queue processing count setting processing and returns to the virtual command transmission queue processing.

On the other hand, if a positive result is obtained in the determination of step S141, the core 32A processes step S143 to step S145 in the same manner as step S130 to step S132 of the transmission queue processing count setting processing described above with reference to FIG. 21, and then ends the virtual command transmission queue processing count setting processing and returns to the virtual command transmission queue processing.

### Virtual Command Reception Queue Processing

### Received Packet Enqueue Processing

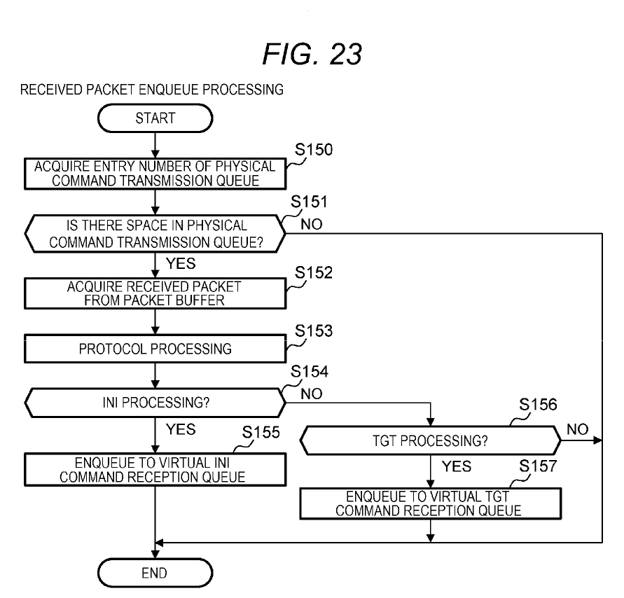

FIG. 23 illustrates a flow of a series of processing (hereinafter, referred to as a received packet enqueue processing) when the core 32A enqueues the communication packet (received packet) from the server system 2 or the data transfer destination storage system 3, which is received via the network and stored in the packet buffer assigned to the core 32A itself in the memory 23, in the virtual initiator command reception queue 62 or the virtual target command reception queue 64 associated with the core 32A itself in the network interface 13 mounted on the storage controller 10.

This processing is executed by each core 32A in the network interface 13. Then, the core 32A first acquires the entry number of the interface-side physical command transmission queue 65 in the same physical port-corresponding command queue group 69 as the virtual initiator command reception queue 62 or the virtual target command reception queue 64 associated with the core 32A itself (S150).

Subsequently, the core 32A determines whether the interface-side physical command transmission queue 65 has a free space (whether the entry number of the interface-side physical command transmission queue 65 is less than a predetermined threshold) (S151). If a negative result is obtained in this determination, the core 32A ends this received packet enqueue processing.

On the other hand, if a positive result is obtained in the determination of step S151, the core 32A acquires the received packet from the corresponding packet buffer (S152) and executes protocol processing of extracting a command or the like from the acquired received packet (S153).

Based on a processing result of the protocol processing in step S153, the core 32A determines whether to perform some initiator processing (processing for the initiator command) on the command or the like extracted from the received packet (S154). If a positive result is obtained in this determination, the core 32A enqueues the command or the like in the virtual initiator command reception queue 62 associated with the core 32A itself (S155), and then ends the received packet enqueue processing.

On the other hand, if a negative result is obtained in the determination of step S154, the core 32A determines whether to perform some target processing (processing for the target command) on the command or the like extracted from the received packet (S156).

If a positive result is obtained in this determination, the core 32A enqueues the command or the like in the virtual target command reception queue 64 associated with the core 32A itself (S157), and then ends the received packet enqueue processing. If a negative result is obtained in this determination, the core 32A ends this received packet enqueue processing.

According to the received packet enqueue processing as described above, when there is no free space in the interface-side physical command transmission queue 65 due to the weighting of the initiator performance and the target performance, the processing of the received packet is limited and the processing of the core 32A can be concentrated on the transmission, so that the interface-side physical command transmission queue 65 can be prevented from being clogged.

Incidentally, if the fetching of the received packet from the packet buffer is not performed for a long time, overflow of the received packet from the packet buffer may occur, but in this case, a retransmission function of TCP can be used to address this problem by having the server system 2 or the data transfer destination storage system 3 retransmit the communication packet.

It should be noted that instead of confirming the entry number of the interface-side physical command transmission queue 65 in step S150, the total number of initiator commands and target commands stored in each virtual initiator command transmission queue 61 and virtual target command transmission queue 63 in the same physical port-corresponding command queue group 69 may be confirmed, and the processing after step S152 may be processed separately for the command or the like (initiator command or the like) from the data transfer destination storage system 3 and the command or the like (target command or the like) from the server system 2.

When the received packet is acquired from the packet buffer, it may be determined whether the corresponding connection is an initiator connection (connection to the data transfer destination storage system 3) or a target connection (connection to the server system 2) with reference to the connection type management table 75 (see FIG. 11), without determining whether the processing for the received packet is the initiator processing or the target processing in step S154 and step S155. The number of initiator commands and target commands processed may be controlled based on this determination.

### Flow of Virtual Command Reception Queue Processing

FIGS. 24A and 24B illustrate more detailed contents of a series of processing executed by any one of the cores 32A in step S31 and step S32 of FIG. 15 and step S57 and step S58 of FIG. 16. The core 32A processes the initiator command stored in the virtual initiator command reception queue 62 and the target command stored in the virtual target command reception queue 64 associated with the core 32A according to the processing procedure illustrated in FIGS. 24A and 24B.

In practice, when the core 32A proceeds to step S31 of FIG. 15 or step S57 of FIG. 16, the core 32A starts the virtual command reception queue processing, and first determines whether an initiator command or a target command is stored in at least one of the virtual initiator command reception queues 62 and the virtual target command reception queues 64 in the corresponding physical port-corresponding command queue group 69 (S160).

Subsequently, the core 32A determines whether a command (initiator command or target command) is stored in only one of the virtual initiator command transmission/reception queue (virtual initiator command transmission queue 61 and virtual initiator command reception queue 62) and the virtual target command transmission/reception queue (virtual target command transmission queue 63 and virtual target command reception queue 64) within a specified time (S161).

If a negative result is obtained in this determination, the core 32A enables the mixed processing mode flag (S162). If a positive result is obtained in the determination of step S161, the core 32A disables the mixed processing mode flag (S163).

Next, the core 32A determines whether the mixed processing mode flag is enabled (S164). If a negative result is obtained in this determination, the core 32A fetches all initiator commands and target commands respectively stored in the virtual initiator command reception queue 62 and the virtual target command reception queue 64 in the corresponding physical port-corresponding command queue group 69, and stores all the commands in the interface-side physical command reception queue 66 in the same physical port-corresponding command queue group 69 (S165). The core 32A then ends the virtual command reception queue processing.

On the other hand, if a positive result is obtained in the determination of step S164, the core 32A executes the same processing (virtual command reception queue processing count setting processing) as the transmission queue processing count setting processing described above with reference to FIG. 21 or 22, using the virtual initiator command reception queue threshold stored in the virtual initiator command reception queue threshold column 72D and the virtual target command reception queue threshold stored in the virtual target command reception queue threshold column 72E of the reception queue operation management table 72 (FIG. 8B). Accordingly, the core 32A sets a processing count for the initiator commands or the target commands to be executed in the virtual command reception queue processing of this time (the maximum number of the target commands and the initiator commands that are to be processed in the virtual command reception queue processing of this time, hereinafter referred to as a virtual command reception queue processing count) (S166).

Subsequently, the core 32A acquires the number of initiator commands or target commands (the entry number of initiator commands or target commands) stored in each virtual initiator command transmission queue 61 and each virtual target command transmission queue 63 in the corresponding physical port-corresponding command queue group 69 (S167).

The core 32A determines whether the processing of step S170 to step S179 has been repeated the same count as the virtual command reception queue processing count set in step S166 (S168).

If a negative result is obtained in this determination, the core 32A determines whether the number of initiator commands stored in each virtual initiator command transmission queue 61 is less than a predetermined threshold (whether there is a free space in any one of the virtual initiator command transmission queues 61) based on the entry number of the initiator command of each virtual initiator command transmission queue 61 acquired in step S167 (S169).

If a negative result is obtained in this determination, the core 32A ends this virtual command reception queue processing. It should be noted that an object of ending the virtual command reception queue processing when there is no free space in any virtual initiator command transmission queue 61 is to limit the processing on the received packet and concentrate the processing of the core 32A on transmission when there is no free space in the virtual initiator command transmission queue 61 due to the weighting of the initiator performance and the target performance, thereby preventing the virtual initiator command transmission queue 61 from being clogged.

On the other hand, if a positive result is obtained in the determination of step S169, the core 32A selects, for example, an entry corresponding to the setting combination pattern determined in the setting combination pattern determination processing described later with reference to FIG. 25 from the entries of the reception queue operation management table 72 (FIG. 8B). It should be noted that an entry designated by the user may be used, or a unique entry may be determined without a plurality of entries. The core 32A determines whether the processing of step S171 to step S173 has been executed the same count as the virtual initiator command reception queue threshold stored in the virtual initiator command reception queue threshold column 72D (FIG. 8B) of the entry selected as described above from the start of the current virtual command reception queue processing to the present (S170). If a positive result is obtained in this determination, the core 32A proceeds to step S174.

If a negative result is obtained in the determination in step S170, the core 32A determines whether there is at least one entry in any one of the virtual initiator command reception queues 62 (whether at least one initiator command is stored in any one of the virtual initiator command reception queues 62) (S171). If a positive result is obtained in this determination, the core 32A proceeds to step S174.

On the other hand, if a negative result is obtained in the determination of step S171, the core 32A fetches one initiator command from any one of the virtual initiator command reception queues 62. The core 32A activates the protocol processing program 43 and stores the initiator command fetched as described above in the interface-side physical command reception queue 66 in the same physical port-corresponding command queue group 69 (S172).

Further, the core 32A increments the processing count of the initiator command stored in the virtual initiator command reception queue 62, which is counted using a counter provided corresponding to the virtual initiator command reception queue 62 (S173).

Subsequently, the core 32A determines whether the number of target commands stored in each virtual target command transmission queue 63 is less than a predetermined threshold (whether there is a free space in the virtual target command transmission queue 63) based on the entry number of the target command of each virtual target command transmission queue 63 acquired in step S167 (S174).

If a negative result is obtained in this determination, the core 32A ends this virtual command reception queue processing. An object of ending the virtual command reception queue processing when there is no free space in any virtual target command transmission queue 63 is to limit the processing on the received packet to concentrate the processing of the core 32A on transmission when there is no free space in the virtual target command transmission queue 63 due to the weighting of the initiator performance and the target performance, thereby preventing the virtual target command transmission queue 63 from being clogged.

On the other hand, if a positive result is obtained in the determination of step S174, the core 32A determines whether the processing of step S175 to step S178 has been repeated the same count as the virtual command reception queue processing count set in step S166 (S175).

If a negative result is obtained in this determination, the core 32A selects an entry of the setting combination pattern described above in step S170 from the entries of the reception queue operation management table 72 (FIG. 8B). The core 32A determines whether the processing of step S176 to step S178 has been executed the same count as the virtual target command reception queue threshold stored in the virtual target command reception queue threshold column 72E (FIG. 8B) of the above-described entry from the start of the current virtual command reception queue processing to the present (S175).

If a positive result is obtained in this determination, the core 32A determines whether there is at least one entry in any one of the virtual target command reception queues 64 (whether at least one target command is stored in any one of the virtual target command reception queues 64) (S176). If a negative result is obtained in this determination, the core 32A proceeds to step S179.

On the other hand, if a negative result is obtained in the determination of step S176, the core 32A fetches one target command from any one of the virtual target command reception queues 64. The core 32A activates the protocol processing program 43 and stores the target command fetched as described above in the interface-side physical command reception queue 66 in the same physical port-corresponding command queue group 69 (S177).

Further, the core 32A increments the processing count of the target command stored in the virtual target command reception queue 64, which is counted using a counter provided corresponding to the virtual target command reception queue 64 (S178).

Further, the core 32A increments a count value of the counter that counts the processing count in step S170 to step S178 (S179), and then returns to step S168. Thereafter, the core 32A repeats the processing of step S168 to step S179 until a positive result is obtained in step S168 or a negative result is obtained in step S169 or step S174.

By repeating this processing, the target commands stored in the virtual target command reception queue 64 are stored in the interface-side physical command reception queue 66 in the same physical port-corresponding command queue group 69 by the same number as the virtual target command reception queue threshold at maximum.

When a positive result is eventually obtained in step S169, the core 32A ends the virtual command reception queue processing.

### Setting Combination Pattern Determination Processing

FIG. 25 illustrates a flow of a series of processing (hereinafter, referred to as setting combination pattern determination processing) of determining, for each session, which transmission queue operation setting combination pattern or reception queue operation setting combination pattern is used in the virtual command transmission queue processing or virtual command reception queue processing of this time among various transmission queue operation setting combination patterns registered in the transmission queue operation management table 71 (FIG. 8A) and various reception queue operation setting combination patterns registered in the reception queue operation management table 72 (FIG. 8B) in the virtual command transmission queue processing described above with reference to FIGS. 17 to 22 and the virtual command reception queue processing described above with reference to FIGS. 24A and 24B. The setting combination pattern determination processing is executed by each core 32A based on the host queue control program 44.

In practice, the core 32A starts the setting combination pattern determination processing shown in FIG. 25 at a predetermined timing, and first measures the round trip time with the server system 2 or the data transfer destination storage system 3 for each session with the server system 2 or the data transfer destination storage system 3 when communicating with the server system 2 or the data transfer destination storage system 3 (S180).

It should be noted that the round trip time can be acquired by measurement when an iSCSI session or a TCP/IP connection is established with the server system 2 or the data transfer destination storage system 3. A ping may be transmitted from the network interface 13 to the server system 2 or the data transfer destination storage system 3 at a predetermined timing to measure and acquire the round trip time for each partner address, and a value acquired after a session or a connection is established may be applied.

Subsequently, the core 32A stores the round trip time for each session acquired or applied in step S180 as a part of connection information of the connection established between the core 32A itself and the server system 2 or the data transfer destination storage system 3 (S181).

Further, the core 32A executes round trip time-corresponding processing of determining, for each session, the transmission queue operation setting combination pattern or the reception queue operation setting combination pattern to be applied in the processing of this time from among the various transmission queue operation setting combination patterns registered in the transmission queue operation management table 71 or the various reception queue operation setting combination patterns registered in the reception queue operation management table 72 based on the round trip time for each session stored in the core 32A itself in step S181 (S182). Thereafter, the core 32A ends the setting combination pattern determination processing.

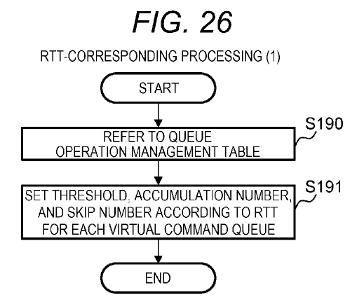

FIG. 26 illustrates specific processing contents of the round trip time-corresponding processing executed by the core 32A in step S182 of the setting combination pattern determination processing.

When the core 32A proceeds to step S182 of the setting combination pattern determination processing, the core 32A starts the round trip time-corresponding processing illustrated in FIG. 26, and first refers to the transmission queue operation management table 71 and the reception queue operation management table 72 (S190).

Then, the core 32A sets each queue threshold (the virtual initiator command transmission queue threshold, the virtual target command transmission queue threshold, the virtual initiator command reception queue threshold, and the virtual target command reception queue threshold), the accumulation number, and the skip number for each session based on the round trip time of each session stored in step S181 of the setting combination pattern determination processing (S191).

Specifically, the core 32A fetches the round trip time stored in step S181 of the setting combination pattern determination processing for one session. When the destination is the server system 2, the core 32A identifies an entry in which the round trip time is stored in the target-side round trip time column 71C from the entries of the transmission queue operation management table 71. Then, the core 32A sets the virtual target command transmission queue threshold, the accumulation number, and the skip number respectively stored in the virtual target command transmission queue threshold column 71E, the accumulation number column 71F, and the skip number column 71G of the entry to the virtual target command transmission queue threshold, the accumulation number, and the skip number when transmitting the communication packet in the session.

Additionally, the core 32A identifies an entry in which the above-described round trip time is stored in the target-side round trip time column 72C from the entries of the reception queue operation management table 72. Then, the core 32A sets the virtual target command reception queue threshold, the accumulation number, and the skip number respectively stored in the virtual target command reception queue threshold column 72E, the accumulation number column 72F, and the skip number column 72G of the entry to the virtual target command reception queue threshold, the accumulation number, and the skip number when receiving the communication packet in the session.

On the other hand, when the destination of the session is the data transfer destination storage system 3, the core 32A identifies an entry in which the round trip time is stored in the initiator-side round trip time column 71B from the entries of the transmission queue operation management table 71. Then, the core 32A sets the virtual initiator command transmission queue threshold, the accumulation number, and the skip number respectively stored in the virtual initiator command transmission queue threshold column 71D, the accumulation number column 71F, and the skip number column 71G of the entry to the virtual initiator command transmission queue threshold, the accumulation number, and the skip number when transmitting the communication packet in the session.

Additionally, the core 32A identifies an entry in which the above-described round trip time is stored in the initiator-side round trip time column 72B from the entries of the reception queue operation management table 72. Then, the core 32A sets the virtual initiator command reception queue threshold, the accumulation number, and the skip number respectively stored in the virtual initiator command reception queue threshold column 72D, the accumulation number column 72F, and the skip number column 72G of the entry to the virtual initiator command reception queue threshold, the accumulation number, and the skip number when receiving the communication packet in the session.

Then, the core 32A executes the above processing for all sessions established by itself. In this way, the core 32A sets, for each session, the queue thresholds (the virtual initiator command transmission queue threshold, the virtual target command transmission queue threshold, the virtual initiator command reception queue threshold, and the virtual target command reception queue threshold), the accumulation number, and the skip number with the destination of the session. Then, the core 32A ends the round trip time-corresponding processing and returns to the setting combination pattern determination processing.

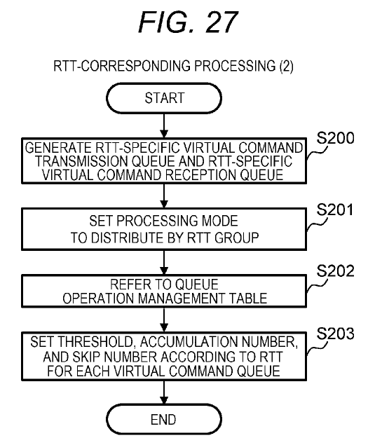

It should be noted that FIG. 27 illustrates another embodiment of the round trip time-corresponding processing executed by the core 32A in step S182 of the setting combination pattern determination processing.

In this embodiment, when the core 32A proceeds to step S182 of the setting combination pattern determination processing, the core 32A starts the round trip time-corresponding processing illustrated in FIG. 27, and first generates a plurality of virtual initiator command transmission queues and a plurality of virtual target command transmission queues for each round trip time (S200).

Specifically, the core 32A generates a plurality of virtual initiator command transmission queues each associated with the round trip time stored in the initiator-side round trip time column 71B of each entry in the transmission queue operation management table 71 (FIG. 8A), and a plurality of virtual target command transmission queues each associated with the round trip time stored in the target-side round trip time column 71C of each entry in the transmission queue operation management table 71. Hereinafter, the virtual initiator command transmission queues and the virtual target command transmission queues are collectively referred to as round trip time-specific virtual command transmission queues.

Subsequently, when distributing the command or the like stored in the interface-side physical command transmission queue 65 to any one of the cores 32A in step S23 of FIG. 15, the core 32A sets itself and other cores 32A to a processing mode (hereinafter referred to as a specific processing mode) in which the command or the like is distributed to the round trip time-specific virtual initiator command transmission queue or virtual target command transmission queue corresponding to the round trip time of the session that transmits the command or the like (S201).

Thereafter, the core 32A sets the queue thresholds (the virtual initiator command transmission queue threshold, the virtual target command transmission queue threshold, the virtual initiator command reception queue threshold, and the virtual target command reception queue threshold), the accumulation number, and the skip number for each session (S202 and S203) in the same manner as in step S190 and step S191 of FIG. 27. Then, the core 32A ends the round trip time-corresponding processing and returns to the setting combination pattern determination processing.

It should be noted that when this embodiment is applied, in step S76 of the virtual command transmission queue processing described above with reference to FIG. 17, the initiator command or the target command stored in the round trip time-specific virtual command transmission queue corresponding to a shorter round trip time is preferentially processed. In this way, the initiator command or the target command that is stored earlier in the round trip time-specific virtual command transmission queue corresponding to a shorter round trip time can be processed earlier, thereby preventing the round trip time-specific virtual command transmission queue from being clogged.

### Effects of Present Embodiment

As described above, in the network interface 13 of the present embodiment, the virtual initiator command transmission queue 61, the virtual initiator command reception queue 62, the virtual target command transmission queue 63, and the virtual target command reception queue 64 are created in association with each core 32A, and the fetching amount of the initiator commands fetched from the virtual initiator command transmission queue 61 and the virtual initiator command reception queue 62 and the fetching amount of the target commands fetched from the virtual target command transmission queue 63 and the virtual target command reception queue 64 are controlled so as to satisfy the expected values of the initiator performance and the target performance set in advance by the user or the like.

As a result, according to the host network interface 13, the initiator performance and the target performance can be maintained at the expected values, and the performance can be stabilized even when one physical port 60 is used for two attributes of the target attribute and the initiator attribute.

### Second Embodiment

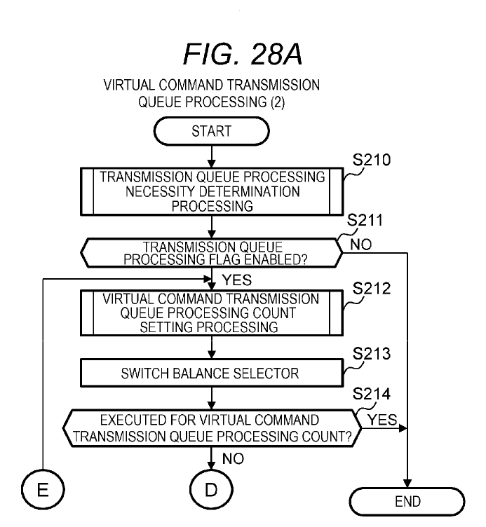

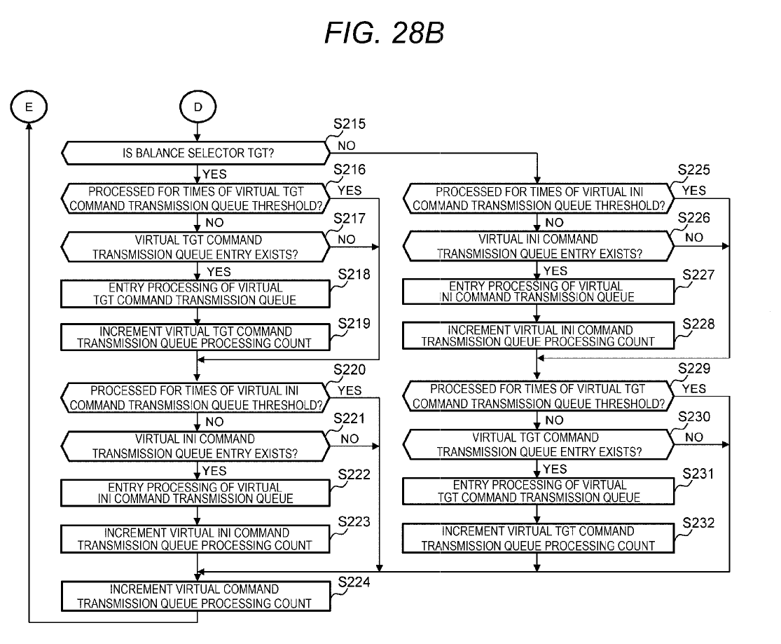

FIGS. 28A and 28B illustrate virtual command transmission queue processing according to the second embodiment. This virtual command transmission queue processing is executed by the corresponding core 32A in step S25 to step S27 of FIG. 15 or step S51 to step S53 of FIG. 16 instead of the virtual command reception queue processing according to the first embodiment described above with reference to FIG. 17.

In practice, when the core 32A proceeds to step S25 in FIG. 15 or step S51 in FIG. 16, the core 32A starts the virtual command transmission queue processing, and first, processes step S210 to step S212 in the same manner as in step S70 to step S72 of the virtual command transmission queue processing of the first embodiment.

Subsequently, the core 32A switches a balance selector, which is a part of the host queue control program 44, to a command type (initiator or target) that is set in advance by the user or the like and that the user or the like desires to be preferentially processed (S213).

Next, the core 32A sets the virtual command transmission queue processing count by executing the virtual command transmission queue processing count setting processing similar to step S72 of the virtual command transmission queue processing of the first embodiment (S214), and then determines whether the balance selector is set to target (S215).

If a positive result is obtained in this determination, the core 32A processes step S216 to step S224 similarly to step S73 to step S82 of the virtual command transmission queue processing of the first embodiment, and then returns to step S212.

On the other hand, if a negative result is obtained in the determination of step S215, the core 32A executes processing in which the "target" is rephrased as the "initiator" in the description of step S73 to step S81 of the virtual command transmission queue processing of the first embodiment (S225 to S232).

Further, the core 32A increments the processing count of the initiator command stored in the virtual initiator command transmission queue 61, which is counted using the counter provided corresponding to the virtual initiator command transmission queue 61 (S224), and then returns to step S212.

Thereafter, the core 32A repeats the processing of step S212 to step S232 until a positive result is obtained in step S214, and when a positive result is eventually obtained in step S214, the core 32A ends the virtual command transmission queue processing.

According to the virtual command transmission queue processing of the present embodiment as described above, the processing of the command type set by the user or the like can be prioritized. Advantages of prioritizing the processing of the command type desired by the user or the like is as follows.

In general, in communication between storage systems or communication between a storage system and a server system, due to a failure in ensuring a buffer in the storage system, subsequent data transmission and reception processing may be interrupted. Such processing interruption may occur during the next or subsequent data transmission and reception processing.

In this case, since a cause of such processing interruption is common to both the initiator processing and the target processing, by first executing one of the initiator processing and the target processing desired by the user or the like, it is possible to execute more target processing or initiator processing than the other.

It should be noted that when the initiator processing and the target processing are equally handled, the balance selector may be sequentially switched from the initiator to the target or from the target to the initiator every time the processing of step S212 in FIG. 28A is performed.

In the virtual command reception queue processing described above with reference to FIGS. 25A and 25B, similarly to the above, the balance selector may be switched to the command type (initiator or target) that the user or the like desires to be preferentially processed.

### Other Embodiments

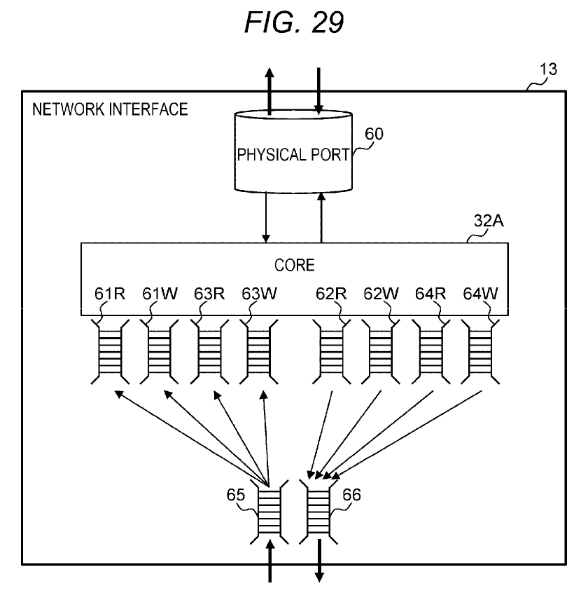

It should be noted that in the first and second embodiments described above, a case has been described in which one virtual initiator command transmission queue 61, one virtual initiator command reception queue 62, one virtual target command transmission queue 63, and one virtual target command reception queue 64 are created in association with each core 32A of the network interface 13, but the present invention is not limited thereto, and for example, as illustrated in FIG. 29, a virtual initiator command transmission queue 61R, a virtual initiator command reception queue 62R, a virtual target command transmission queue 63R, and a virtual target command reception queue 64R for read commands, and a virtual initiator command transmission queue 61W, a virtual initiator command reception queue 62W, a virtual target command transmission queue 63W, and a virtual target command reception queue 64W for write commands may be created in association with each core 32A.

In this case, a read command among the initiator commands and the target commands is stored in the virtual initiator command transmission queue 61R, the virtual initiator command reception queue 62R, the virtual target command transmission queue 63R, and the virtual target command reception queue 64R for read commands, and a write command among the initiator commands and the target commands is stored in the virtual initiator command transmission queue 61W, the virtual initiator command reception queue 62W, the virtual target command transmission queue 63W, and the virtual target command reception queue 64W for write commands.

The following advantages are obtained. Normally, since processing characteristics are different between read processing and write processing, it is desirable to change the virtual initiator command transmission queue threshold and the virtual target command transmission queue threshold described above with reference to FIG. 8A and the virtual initiator command reception queue threshold and the virtual target command reception queue threshold described above with reference to FIG. 8B for each command attribute (read command or write command).

Therefore, by separately preparing the virtual initiator command transmission queue 61, the virtual initiator command reception queue 62, the virtual target command transmission queue 63, and the virtual target command reception queue 64 for the read commands and the write commands, and by preparing different transmission queue operation management tables 71 (FIG. 8A) and reception queue operation management tables 72 (FIG. 8B) for the read commands and the write commands, respectively, the initiator performance and the target performance of the network interface 13 can be more finely controlled.

Since a delay amount of the round trip time is usually different depending on a distance from the storage controller 10 to the server system 2 or the data transfer destination storage system 3, it is desirable to change the virtual initiator command transmission queue threshold and the virtual target command transmission queue threshold, and the virtual initiator command reception queue threshold and the virtual target command reception queue threshold according to the distance from the storage controller 10.

As one solution, as described above with reference to FIG. 28, there is a method of creating a virtual initiator command transmission queue and a virtual target command transmission queue, and a virtual initiator command reception queue and a virtual target command reception queue for each round trip time. However, according to this method, it is necessary to ensure a large area for creating the virtual command transmission queue and the virtual command reception queue on the memory 23.

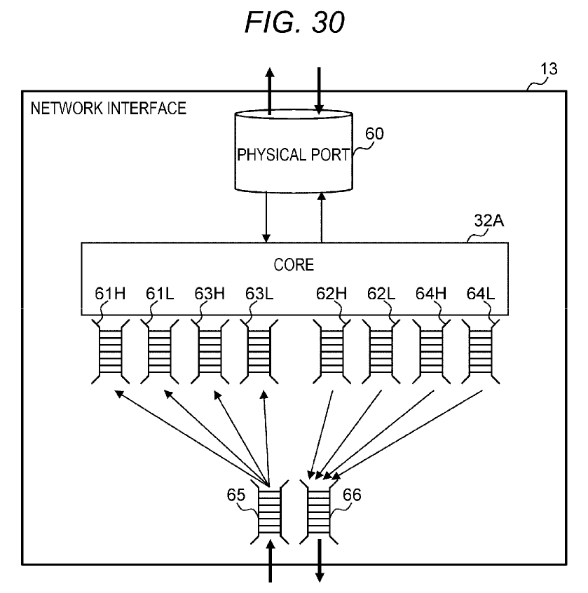

Therefore, for example, as illustrated in FIG. 30, a virtual initiator command transmission queue 61H, a virtual initiator command reception queue 62H, a virtual target command transmission queue 63H, and a virtual target command reception queue 64H for a high-delay round trip time and a virtual initiator command transmission queue 61L, a virtual initiator command reception queue 62L, a virtual target command transmission queue 63L, and a virtual target command reception queue 64L for a low-delay round trip time may be created in association with each core 32A.

In this case, among the initiator commands and the target commands, the initiator commands and the target commands for the server system 2 or the data transfer destination storage system 3 installed at a long distance and having a high-delay round trip time is stored in the virtual initiator command transmission queue 61H, the virtual initiator command reception queue 62H, the virtual target command transmission queue 63H, and the virtual target command reception queue 64H for a high-delay, and the initiator commands and the target commands for the server system 2 or the data transfer destination storage system 3 installed at a short distance and having a low-delay round trip time are stored in the virtual initiator command transmission queue 61L, the virtual initiator command reception queue 62L, the virtual target command transmission queue 63L, and the virtual target command reception queue 64L for a low-delay.

In this case, the transmission queue operation management table 71 (FIG. 8A) and the reception queue operation management table 72 (FIG. 8B) are also prepared for high-delay and low-delay. In this way, it is possible to more finely control the initiator performance and the target performance of the network interface 13.

It should be noted that the technique described above with reference to FIG. 29 and the technique described above with reference to FIG. 30 may be combined to create the virtual initiator command transmission queue 61, the virtual initiator command reception queue 62, the virtual target command transmission queue 63, and the virtual target command reception queue 64 for the read command and the high-delay, the read command and the low-delay, the write command and the high-delay, and the write command and the low-delay, respectively, in association with each core 32A. In this case, the transmission queue operation management table 71 and the reception queue operation management table 72 may also be prepared for the read command and the high-delay, the read command and the low-delay, the write command and the high-delay, and the write command and the low-delay.

Further, in the first and second embodiments described above, a case has been described in which each core 32A adjusts the fetching amount of the initiator commands from the virtual initiator command transmission queue 61 and the virtual initiator command reception queue 62 created in association with the core 32A itself, and the fetching amount of the target commands from the virtual target command transmission queue 63 and the virtual target command reception queue 64 created in association with the core 32A itself, so as to satisfy the expected values for the initiator performance and the target performance that are set in advance, but the present invention is not limited thereto, and at least one of the fetching amount of the initiator commands from the virtual initiator command transmission queue 61 and the virtual initiator command reception queue 62 and the fetching amount of the target commands from the virtual target command transmission queue 63 and the virtual target command reception queue 64 created in association with the core 32A itself may be adjusted to satisfy the expected values for the initiator performance and the target performance that are set in advance.

Further, in the first and second embodiments described above, a case has been described in which balance control between a communication amount as an initiator and a communication amount as a target based on the aggregation port performance stabilization function according to the present embodiment is performed for both transmission and reception, but the present invention is not limited thereto, and the balance control may be performed only for transmission or only for reception.

### INDUSTRIAL APPLICABILITY

The present invention can be widely applied to network interfaces having various configurations to which protocol processing during communication between a host on which the present invention is mounted and an external device is offloaded from the host.

What is claimed is:

1. A network interface to which protocol processing during communication between a host and an external device is offloaded from the host, the network interface comprising:
a physical port that is connected to the external device; and
a processor including one or a plurality of cores configured to communicate with the external device via the physical port, wherein
a virtual first virtual command transmission queue in which a command to be transmitted to the external device having an initiator attribute is stored and a virtual second virtual command transmission queue in which a command to be transmitted to the external device having a target attribute is stored are created in association with each of the cores,
the command from the host for the external device having the initiator attribute is stored in the first virtual command transmission queue created in association with any one or a corresponding one of the cores, and the command from the host for the external device having the target attribute is stored in the second virtual command transmission queue created in association with any one or a corresponding one of the cores,
each of the cores fetches the command stored in the first and second virtual command transmission queues created in association with the core itself from the first or second virtual command transmission queue and transmits the command to the corresponding external device, and
each of the cores adjusts at least one of a fetching amount of the command from the first virtual command transmission queue and a fetching amount of the command from the second virtual command transmission queue created in association with the core itself to satisfy preset expected values for initiator performance and target performance.

2. The network interface according to claim 1, wherein
a virtual first virtual command reception queue in which a command from the external device having the initiator attribute is stored and a virtual second virtual command reception queue in which a command from the external device having the target attribute is stored are created in association with each of the cores,
the command from the external device having the initiator attribute is stored in the first virtual command reception queue created in association with any one or a corresponding one of the cores, and the command from the external device having the target attribute is stored in the second virtual command reception queue created in association with any one or a corresponding one of the cores,
each of the cores fetches the command stored in the first and second virtual command reception queues created in association with the core itself and transmits the command to the host, and
each of the cores adjusts at least one of a fetching amount of the command from the first virtual command transmission queue and the first virtual command reception queue, and a fetching amount of the command from the second virtual command transmission queue and the second virtual command reception queue created in association with the core itself, to satisfy the expected values.

3. The network interface according to claim 1, wherein
each of the cores establishes a session with the same external device having the initiator attribute, and
any one or a dedicated one of the cores distributes the command from the host to any one or a corresponding one of the cores and stores the command in the first or second virtual command transmission queue created in association with the core, and when distributing the command for the external device having the initiator attribute from the host to any one of the cores, the command for the external device having the initiator attribute is preferentially distributed to the core having fewer commands stored in the corresponding second virtual command transmission queue.

4. The network interface according to claim 1, further comprising:
a packet buffer in which a communication packet from the external device including the command is temporarily stored; and
a physical command transmission queue in which the command from the host is temporarily stored, wherein
any one or a dedicated one of the cores fetches the communication packet stored in the packet buffer, extracts the command from the fetched communication packet, distributes the extracted command to any one or a corresponding one of the cores, and stores the command in the first or second virtual command transmission queue created in association with the core,
the command stored in the physical command transmission queue is fetched from the physical command transmission queue and distributed to and stored in the first or second virtual command transmission queue associated with any one of the cores, and
any one or a dedicated one of the cores limits a fetching amount of the communication packet from the packet buffer based on a usage amount of the physical command transmission queue.

5. The network interface according to claim 1, wherein
a maximum number of the commands allowed to be fetched in fetching processing of the command from the first and second virtual command transmission queues executed at a predetermined timing is set for each of the first and second virtual command transmission queues according to the expected values for the initiator performance and the target performance and a round trip time with the external device having the initiator attribute or the target attribute as a communication partner.

6. The network interface according to claim 2, wherein
a maximum number of the commands allowed to be fetched in fetching processing of the command from the first and second virtual command reception queues executed at a predetermined timing is set for each of the first and second virtual command reception queues according to the expected values for the initiator performance and the target performance and a round trip time with the external device having the initiator attribute or the target attribute as a communication partner.

7. The network interface according to claim 6, wherein
the core is configured to
skip fetching of the command from the first or second virtual command transmission queue when the number of the command stored in the first or second virtual command transmission queue is equal to or less than a preset first accumulation amount during the fetching processing of the command from the first and second virtual command reception queues, and
skip fetching of the command from the first or second virtual command reception queue when the number of the command stored in the first or second virtual command reception queue is equal to or less than a preset second accumulation amount during the fetching processing of the command from the first and second virtual command reception queues.

8. The network interface according to claim 1, wherein
a maximum number of times of skipping the fetching of the command from each of the first virtual command transmission queue and the second virtual command transmission queue is set.

9. The network interface according to claim 2, wherein
a maximum number of times of skipping the fetching of the command from each of the first virtual command reception queue and the second virtual command reception queue is set.

10. The network interface according to claim 1, wherein
the core is configured to
sequentially and alternately fetch the command stored in the first virtual command transmission queue and the command stored in the second virtual command transmission queue from the first and second virtual command transmission queues during fetching processing of the command from the first and second virtual command transmission queues, and
switch, as necessary, from which of the first and second virtual command transmission queues the command is first fetched during the fetching processing of the command.

11. A control method of a network interface to which protocol processing during communication between a host and an external device is offloaded from the host, the network interface including a physical port that is connected to the external device, and a processor including one or a plurality of cores configured to communicate with the external device via the physical port, the control method comprising:
a first step of creating, in association with each of the cores, a virtual first virtual command transmission queue in which a command to be transmitted to the external device having an initiator attribute is stored and a virtual second virtual command transmission queue in which a command to be transmitted to the external device having a target attribute is stored;
a second step of storing the command from the host for the external device having the initiator attribute in the first virtual command transmission queue created in association with any one or a corresponding one of the cores, and storing the command from the host for the external device having the target attribute in the second virtual command transmission queue created in association with any one or a corresponding one of the cores; and
a third step of fetching, by each of the cores, the command stored in the first and second virtual command transmission queues created in association with the core itself from the first or second virtual command transmission queue and transmits the command to the corresponding external device, wherein
in the third step, each of the cores adjusts at least one of a fetching amount of the command from the first virtual command transmission queue and a fetching amount of the command from the second virtual command transmission queue created in association with the core itself to satisfy preset expected values for initiator performance and target performance.

12. The control method of the network interface according to claim 11, wherein
in the first step, the network interface creates, in association with each of the cores, a virtual first virtual command reception queue in which a command from the external device having the initiator attribute is stored and a virtual second virtual command reception queue in which a command from the external device having the target attribute is stored,
in the second step, the network interface stores the command from the external device having the initiator attribute in the first virtual command reception queue created in association with any one or a corresponding one of the cores, and stores the command from the external device having the target attribute in the second virtual command reception queue created in association with any one or a corresponding one of the cores,
in the third step, each of the cores of the network interface fetches the command stored in the first and second virtual command reception queues created in association with the core itself and transmits the command to the host, and
in the third step, each of the cores adjusts at least one of a fetching amount of the command from the first virtual command transmission queue and the first virtual command reception queue, and a fetching amount of the command from the second virtual command transmission queue and the second virtual command reception queue created in association with the core itself, to satisfy the expected values.

13. The control method of the network interface according to claim 11, wherein
each of the cores establishes a session with the same external device having the initiator attribute, and
in the second step, any one or a dedicated one of the cores distributes the command from the host to any one or a corresponding one of the cores and stores the command in the first or second virtual command transmission queue created in association with the core, and when distributing the command for the external device having the initiator attribute from the host to any one of the cores, the command for the external device having the initiator attribute is preferentially distributed to the core having fewer commands stored in the corresponding second virtual command transmission queue.

14. The control method of the network interface according to claim 11, wherein
the network interface further includes
a packet buffer in which a communication packet from the external device including the command is temporarily stored, and
a physical command transmission queue in which the command from the host is temporarily stored,
in the second step, any one or a dedicated one of the cores fetches the communication packet stored in the packet buffer, extracts the command from the fetched communication packet, distributes the extracted command to any one or a corresponding one of the cores, and stores the command in the first or second virtual command transmission queue created in association with the core,
in the second step, the command stored in the physical command transmission queue is fetched from the physical command transmission queue and distributed to and stored in the first or second virtual command transmission queue associated with any one of the cores, and
in the second step, any one or a dedicated one of the cores limits a fetching amount of the communication packet from the packet buffer based on a usage amount of the physical command transmission queue.

15. The control method of the network interface according to claim 11, wherein
a maximum number of the commands allowed to be fetched in fetching processing of the command from the first and second virtual command transmission queues executed periodically in the second step is set for each of the first and second virtual command transmission queues according to the expected values for the initiator performance and the target performance and a round trip time with the external device having the initiator attribute or the target attribute as a communication partner.

16. The control method of the network interface according to claim 12, wherein
a maximum number of the commands allowed to be fetched in fetching processing of the command from the first and second virtual command reception queues executed periodically in the second step is set for each of the first and second virtual command reception queues according to the expected values for the initiator performance and the target performance and a round trip time with the external device having the initiator attribute or the target attribute as a communication partner.

17. The control method of the network interface according to claim 16, wherein
in the second step, the core is configured to
skip fetching of the command from the first or second virtual command transmission queue when the number of the command stored in the first or second virtual command transmission queue is equal to or less than a preset first accumulation amount during the fetching processing of the command from the first and second virtual command reception queues, and
skip fetching of the command from the first or second virtual command reception queue when the number of the command stored in the first or second virtual command reception queue is equal to or less than a preset second accumulation amount during the fetching processing of the command from the first and second virtual command reception queues.

18. The control method of the network interface according to claim 11, wherein
a maximum number of times of skipping the fetching of the command from each of the first virtual command transmission queue and the second virtual command transmission queue is set.

19. The control method of the network interface according to claim 12, wherein
a maximum number of times of skipping the fetching of the command from each of the first virtual command reception queue and the second virtual command reception queue is set.

20. The control method of the network interface according to claim 11, wherein
in the second step, the core is configured to
sequentially and alternately fetch the command stored in the first virtual command transmission queue and the command stored in the second virtual command transmission queue from the first and second virtual command transmission queues during fetching processing of the command from the first and second virtual command transmission queues, and
switch, as necessary, from which of the first and second virtual command transmission queues the command is first fetched during the fetching processing of the command.
